(19) United States
(12) Patent Application Publication
(10) Pub. No.: US 2026/0186492 A1
(43) Pub. Date: Jul. 2, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Kanghee LEE, Suwon-si (KR); Junghee KIM, Suwon-si (KR); Seungwon CHA, Suwon-si (KR); Inhak NA, Suwon-si (KR)

(73) Assignee: SAMSUNG ELECTRONICS CO., LTD., Suwon-si (KR)

(21) Appl. No.: 19/548,263

(22) Filed: Feb. 24, 2026

Related U.S. Application Data
(63) Continuation of application No. PCT/KR2025/020866, filed on Dec. 5, 2025.

(30) Foreign Application Priority Data
Dec. 10, 2024 (KR) 10-2024-0182732

(51) Int. Cl. G16Y 40/35; G05D 1/246; G05D 105/80; G05D 109/10; G05D 111/30; G05D 111/50; H04B 17/318; H04W 4/44

(52) U.S. Cl. CPC G05D 1/246; G16Y 40/35; H04B 17/318; H04W 4/44; G05D 2105/80; G05D 2109/10; G05D 2111/32; G05D 2111/56

(57) ABSTRACT

An electronic apparatus may include memory storing instructions, a communication interface, a sensor part, and at least one processor including processing circuitry, wherein the instructions, when executed by the at least one processor individually or collectively, cause the electronic apparatus to obtain a map based on sensing data related to an environment that was obtained through the sensor part during driving, and based on a target area, on the basis of the sensing data existing among a plurality of areas included in the map, identify a target device corresponding to control of the environment of the target area among a plurality of external devices, and transmit a control command for controlling the target device to the target device through the communication interface.

### CROSS-REFERENCE TO RELATED APPLICATION(S)

This application is a bypass continuation of International Application No. PCT/KR2025/020866, filed on Dec. 5, 2025, which is based on and claims priority to Korean Patent Application No. 10-2024-0182732, filed on Dec. 10, 2024, in the Korean Intellectual Property Office, the disclosures of which are incorporated by reference herein in their entireties.

### BACKGROUND

### 1. Field

The disclosure relates to an electronic apparatus and a controlling method thereof, and more particularly, to an electronic apparatus that controls an Internet-of-Things (IoT) device based on sensing data for the ambient environment, and a controlling method thereof.

### 2. Description of Related Art

An IoT device may be managed by being connected to a cloud server. An IoT device arranged in a specific space may be connected to a cloud server. A user may use a host device for controlling the IoT device connected to the cloud server. The host device may include an access point (AP) device.

The AP device may perform a function of a repeater that connects the cloud server and the IoT device. The cloud server may collect various types of data for the space wherein the IoT device exists. For example, the cloud server may automatically control a temperature by collecting temperatures of a specific space.

The IoT device may transmit the sensed information to the AP device. Meanwhile, data loss may be generated as the distance between the AP device and the IoT device increases. Also, if the collected sensing information is not correct, there is a problem of mismatch between a subject for control and a goal of control.

### SUMMARY

The disclosure may provide an electronic apparatus that directly obtains sensing data through a mobile electronic apparatus, and generates a control command for controlling an IoT device based on the sensing data, and a controlling method thereof.

According to one or more embodiments, an electronic apparatus includes memory storing instructions, a communication interface, a sensor part, and at least one processor including processing circuitry, wherein the instructions, when executed by the at least one processor individually or collectively, cause the electronic apparatus to obtain a map based on sensing data related to an environment, the sensing data being obtained through the sensor part while the electronic apparatus is being driven, and based on a target area that is determined based on the sensing data existing among a plurality of areas in the map, identify a target device corresponding to control of the environment of the target area among a plurality of external devices, and transmit a control command through the communication interface to the target device for controlling the target device.

The sensor part may include at least one of a temperature sensor, a humidity sensor, an illumination sensor, or an air pollution sensor, and the sensing data may include data related to at least one of a temperature, humidity, illumination, air pollution, or ozone concentration.

The air pollution sensor may include a first air pollution sensor configured to measure chemical pollution and a second air pollution sensor configured to measure particulate pollution.

The electronic apparatus may include a moving element, and the instructions, when executed by the at least one processor individually or collectively, may further cause the electronic apparatus to obtain a moving path based on a driving map stored in the memory, obtain the sensing data while the electronic device is being driven based on the moving path, and obtain the map from the driving map based on the obtained sensing data.

The instructions, when executed by the at least one processor individually or collectively, may further cause the electronic apparatus to, while moving based on the moving path, obtain signal data corresponding to signal strength of an access point (AP) device wirelessly connected with the plurality of external devices, and obtain the map from the driving map based on the obtained signal data.

The instructions, when executed by the at least one processor individually or collectively, may further cause the electronic apparatus to, based on the target area, on the basis of the sensing data existing, obtain signal strength corresponding to a target location of the target area, and based on the signal strength being greater than or equal to a threshold value, transmit the control command to the target device through the communication interface via the AP device.

The instructions, when executed by the at least one processor individually or collectively, may further cause the electronic apparatus to, based on the signal strength being smaller than the threshold value, perform control to move to the target location through the moving element, and transmit the control command to the target device through the communication interface in the target location to which the electronic apparatus moved.

The map may include at least one environment UI indicating a sensing value included in the sensing data.

The instructions, when executed by the at least one processor individually or collectively, may further cause the electronic apparatus to obtain a plurality of representative sensing values corresponding to each of the plurality of areas included in the map, and obtain an area having a representative sensing value of the plurality of representative sensing values, wherein a difference value between an average sensing value obtained from the plurality of representative sensing values and the representative sensing value is greater than or substantially equal to a threshold value of the target area.

The instructions, when executed by the at least one processor individually or collectively, may further cause the electronic apparatus to obtain a correction value corresponding to the control of the environment of the target area based on the difference value, and obtain the control command based on a control code corresponding to the identified target device and the correction value.

In a controlling method of an electronic apparatus including a sensor part according to one or more embodiments, the controlling method includes the steps of obtaining a map based on sensing data related to an environment that was obtained by the sensor part while the electronic apparatus is being driven, and based on a target area that is determined based on the sensing data existing among a plurality of areas in the map, identifying a target device corresponding to control of the environment of the target area among a plurality of external devices, and transmitting a control command to the target device for controlling the target device.

The sensor part may include at least one of a temperature sensor, a humidity sensor, an illumination sensor, or an air pollution sensor, and the sensing data may include data related to at least one of a temperature, humidity, illumination, air pollution, or ozone concentration.

The air pollution sensor may include a first air pollution sensor configured to measure chemical pollution and a second air pollution sensor configured to measure particulate pollution.

The electronic apparatus may include a moving element, and in the step of obtaining the map, a moving path may be obtained based on a driving map stored in the electronic apparatus, the sensing data may be obtained while driving based on the moving path, and the map may be obtained from the driving map based on the obtained sensing data.

In the step of obtaining the map, while moving based on the moving path, signal data corresponding to signal strength of an access point (AP) device wirelessly connected with the plurality of external devices may be obtained, and the map may be obtained from the driving map based on the obtained signal data.

In the controlling method, based on the target area, on the basis of the sensing data existing, signal strength corresponding to the location of the target area may be obtained, and based on the signal strength being greater than or equal to a threshold value, the control command may be transmitted to the target device via the AP device.

In the step of transmitting the control command, based on the signal strength being smaller than the threshold value, control may be performed to move to the target location through the moving element, and the control command may be transmitted to the target device in the target location to which the electronic apparatus moved.

The map may include at least one environment UI indicating a sensing value included in the sensing data.

The controlling method may include the steps of obtaining a plurality of representative sensing values corresponding to each of the plurality of areas included in the map, and obtaining an area wherein a difference value between an average sensing value obtained from the plurality of representative sensing values and the representative sensing value is greater than or equal to a threshold value as the target area.

The controlling method may include the steps of obtaining a correction value corresponding to the control of the environment of the target area based on the difference value, and obtaining the control command based on a control code corresponding to the identified target device and the correction value.

### BRIEF DESCRIPTION OF DRAWINGS

FIG. 1 is a diagram for illustrating a driving operation of an electronic apparatus according to one or more embodiments;

FIG. 2 is a block diagram illustrating an electronic apparatus according to one or more embodiments;

FIG. 3 is a block diagram for illustrating a detailed configuration of the electronic apparatus in FIG. 2 according to one or more embodiments;

FIG. 4 is a diagram for illustrating an operation of an electronic apparatus of communicating with an external device according to one or more embodiments;

FIG. 5 is a diagram for illustrating an operation of transmitting a control command to a target device according to one or more embodiments;

FIG. 6 is a diagram for illustrating an operation of generating a sensing map according to one or more embodiments;

FIG. 7 is a diagram for illustrating a driving map according to one or more embodiments;

FIG. 8 is a diagram for illustrating a sensing map according to one or more embodiments;

FIG. 9 is a diagram for illustrating a sensing map according to one or more embodiments;

FIG. 10 is a diagram for illustrating an environment UI corresponding to sensing data according to one or more embodiments;

FIG. 11 is a diagram for illustrating an environment UI corresponding to sensing data according to one or more embodiments;

FIG. 12 is a diagram for illustrating an environment UI displayed on a sensing map according to one or more embodiments;

FIG. 13 is a diagram for illustrating an operation of determining a target area according to one or more embodiments;

FIG. 14 is a diagram for illustrating a calculation process used in determining a target area according to one or more embodiments;

FIG. 15 is a diagram for illustrating an operation of generating a control command for controlling a target device according to one or more embodiments;

FIG. 16 is a diagram for illustrating an operation of transmitting a control command by using signal strength according to one or more embodiments;

FIG. 17 is a diagram for illustrating a sensing map indicating signal strength according to one or more embodiments;

FIG. 18 is a diagram for illustrating a sensing map indicating signal strength according to one or more embodiments;

FIG. 19 is a diagram for illustrating an operation of outputting a projection image according to one or more embodiments;

FIG. 20 is a diagram for illustrating an operation of outputting a projection image according to one or more embodiments;

FIG. 21 is a diagram for illustrating an operation of displaying a sensing map for each step according to one or more embodiments;

FIG. 22 is a diagram for illustrating a sensing map including an environment UI and a signal UI according to one or more embodiments;

FIG. 23 is a diagram for illustrating an operation of controlling an environment of another space according to one or more embodiments;

FIG. 24 is a diagram for illustrating an operation of recognizing a user according to one or more embodiments;

FIG. 25 is a diagram for illustrating an operation of controlling a target device in consideration of a user according to one or more embodiments;

FIG. 26 is a diagram for illustrating a plurality of communication methods according to one or more embodiments;

FIG. 27 is a diagram for illustrating a screen related to environment control according to one or more embodiments;

FIG. 28 is a diagram for illustrating an operation of transmitting a control command to an IoT device through a server according to one or more embodiments;

FIG. 29 is a diagram for illustrating an operation of generating a sensing map at a server according to one or more embodiments; and

FIG. 30 is a diagram for illustrating a controlling method of an electronic apparatus according to one or more embodiments.

### DETAILED DESCRIPTION

Hereinafter, the disclosure will be described in detail with reference to the accompanying drawings.

To the greatest extent possible, the embodiments of the disclosure are described using general and customary terms in accordance with their plain meaning as understood by one of ordinary skill in the art. However, the meanings of these terms may vary depending on previous court decisions, the emergence of new technologies, the intention of those skilled in the art who work in the pertinent field(s), etc. Further, in particular cases, there may be terms that are specifically defined by the disclosure, and in such cases, the meaning of the terms will be described in detail in the relevant descriptions in the disclosure. Accordingly, the terms used in the disclosure should be defined based on their plain and/or customary meaning in the context of the overall content of the disclosure, and not based merely on the terms themselves.

Also, in this specification, expressions such as “have,” “may have,” “comprise,” “may comprise,” “include,” “may include,” etc., denote the existence of such characteristics (e.g., elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may describe various elements regardless of any order and/or degree of importance. Also, such expressions are used only to distinguish one element from another element, and are not intended to limit the elements.

Meanwhile, the description in the disclosure that one element (e.g., a first element) is “operatively or communicatively coupled with/to” or “connected to” another element (e.g., a second element) should be interpreted to include both the case where the one element is directly coupled to the another element, and the case where the one element is coupled to the another element through still another element (e.g., a third element).

Also, singular expressions include plural expressions, unless defined obviously differently in the context. In addition, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the embodiments of the disclosure, “a module” or “a part” may perform at least one function or operation, and may be implemented as hardware or software, or as a combination of hardware and software. Also, a plurality of “modules” or “parts” may be integrated into at least one module and implemented as at least one processor, excluding “a module” or “a part” that needs to be implemented as specific hardware.

Also, in this specification, the term “user” may refer to a person who uses an electronic apparatus or an apparatus using an electronic apparatus (e.g., an artificial intelligence electronic apparatus).

Hereinafter, one or more embodiments of the disclosure will be described in more detail with reference to the accompanying drawings.

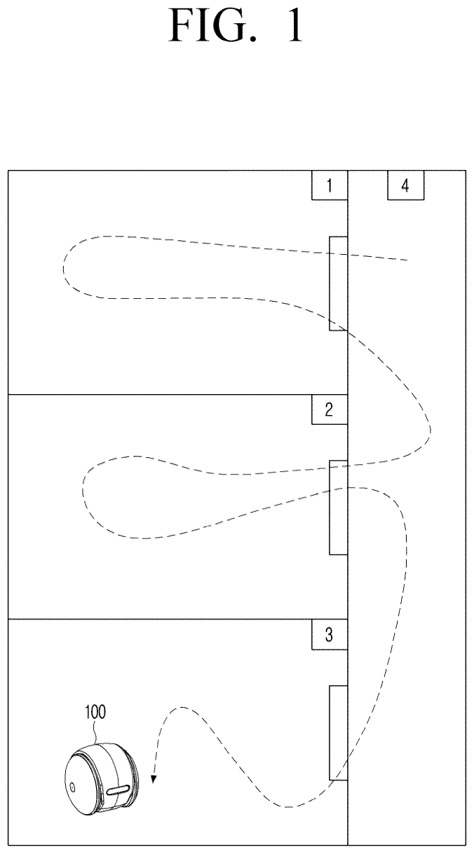

FIG. 1 is a diagram for illustrating a driving operation of an electronic apparatus 100 according to one or more embodiments.

Referring to FIG. 1, the electronic apparatus 100 may perform driving, i.e., be driven, perform autonomous driving, etc., for analysis of the space wherein the electronic apparatus 100 is located. The electronic apparatus 100 may obtain analysis data for the space during driving. The electronic apparatus 100 may generate a driving map as the analysis result. The electronic apparatus 100 may perform a designated function based on the driving map.

The electronic apparatus 100 may obtain driving data, and generate a driving map based on the driving data. The driving data may include at least one of image data obtained through a camera (or an image sensor), depth data obtained through a depth camera (or a depth sensor), distance data obtained through a distance sensor, or infrared data obtained through an infrared sensor. As an example, the distance sensor may include a Time of Flight (ToF) sensor. The electronic apparatus 100 may determine the structure for the space by analyzing the driving data. The electronic apparatus 100 may generate a driving map corresponding to the space based on the determined structure.

The electronic apparatus 100 may drive on a moving path corresponding to a control command based on the driving map.

As an example, the electronic apparatus 100 may move to a designated location for performing the control command by using the driving map.

As an example, the electronic apparatus 100 may obtain sensing data which includes data related to the environment of the space while driving in the overall space through the driving map. The environment may include at least one of the temperature, humidity, illumination, air pollution, or ozone. The electronic apparatus 100 may obtain (or collect) sensing data related to the environment. The electronic apparatus 100 may identify in which location the sensing data is obtained based on the driving map. The electronic apparatus 100 may match the sensing data and the location wherein the sensing data is obtained, and store the information. As an example, the electronic apparatus 100 may obtain a temperature sensing value of a first location, and a temperature sensing value of a second location.

The electronic apparatus 100 may control various IoT devices existing in the space by analyzing the sensing data related to the environment. The electronic apparatus 100 may control the environment by controlling the IoT devices arranged in the space. The operation of controlling the environment may include an operation of changing (or controlling) at least one of the temperature, humidity, illumination, air pollution, or ozone.

The electronic apparatus 100 may identify a plurality of areas. The electronic apparatus 100 may divide the driving map into a plurality of areas based on the overall driving data. The electronic apparatus 100 may identify the arrangement locations of the IoT devices arranged in each of the plurality of areas divided in the driving map. The electronic apparatus 100 may identify in which locations on the driving map the IoT devices are arranged.

As an example, it is assumed that the electronic apparatus 100 controls the temperature of the first location. The electronic apparatus 100 may identify a target space including the first location. The electronic apparatus 100 may control the temperature of the first location by controlling a target device arranged in the target space.

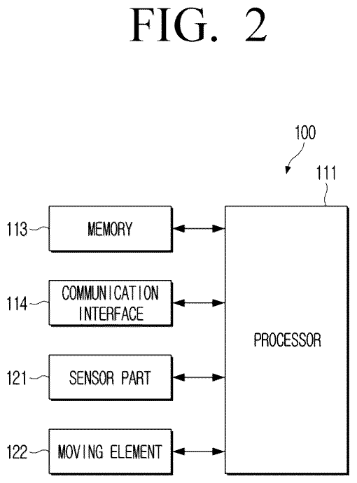

FIG. 2 is a block diagram illustrating the electronic apparatus 100 according to one or more embodiments.

The electronic apparatus 100 may include memory 113 storing instructions, a communication interface 114, a sensor part 121, and at least one processor 111 including processing circuitry.

The at least one processor 111 may generate a sensing map based on sensing data related to an environment that was obtained through the sensor part 121 during driving.

If a target area is determined based on the sensing data in a plurality of areas identified in the sensing map, the at least one processor 111 may identify a target device for controlling the environment of the target area among a plurality of Internet of Things (IoT) devices that can be controlled.

The at least one processor 111 may generate a control command for controlling the target device, and provide the control command to the target device through the communication interface 114.

The sensor part 121 may include at least one of a temperature sensor, a humidity sensor, an illumination sensor, an air pollution sensor, or an ozone sensor. The sensing data may include data related to at least one of the temperature, humidity, illumination, air pollution, or ozone concentration.

The at least one processor 111 may obtain the sensing data including at least one of the temperature, humidity, illumination, air pollution, or ozone through the sensor part 121. The sensing data may also be described as environment data.

The air pollution sensor may include a first air pollution sensor that measures chemical pollution and a second air pollution sensor that measures particulate pollution.

The at least one processor 111 may obtain the first air pollution data indicating whether predetermined gas is included in the air through the first air pollution sensor. The at least one processor 111 may identify how much harmful gas is included in the air based on the first air pollution data.

The at least one processor 111 may obtain the second air pollution data indicating the degree of inclusion of fine dust in the air through the second air pollution sensor. The at least one processor 111 may identify how much ultrafine dust or fine dust is included in the air based on the second air pollution data. Ultrafine dust or fine dust may be classified based on particle sizes of dust. The standard of classification may be changed according to a user's setting.

The at least one processor 111 may obtain a moving path based on a driving map stored in the memory 113. The moving path may be changed according to the user's setting. The moving path may be a path for moving in the entire space of a subject for driving. The at least one processor 111 may obtain sensing data while driving based on the moving path. The at least one processor 111 may generate a sensing map by applying the sensing data to the driving map.

The driving map may be a map for a moving path. The sensing map may be a map for indicating sensing data. Also, the sensing map may be a map for indicating information related to a subject for sensing (an environment) in a location wherein sensing data is obtained. As an example, the sensing map may be a map for indicating at least one of temperature distribution, humidity distribution, illumination distribution, or air pollution distribution of a space. The sensing map may also be described as an environment map.

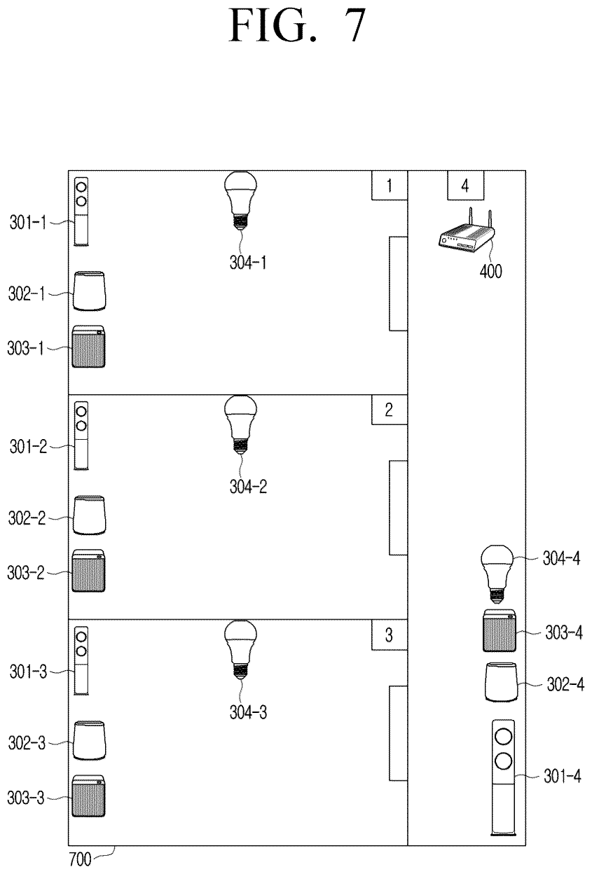

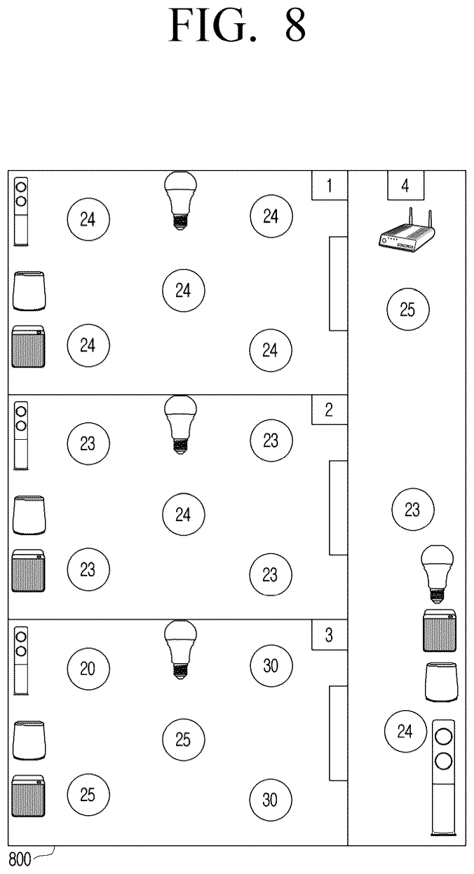

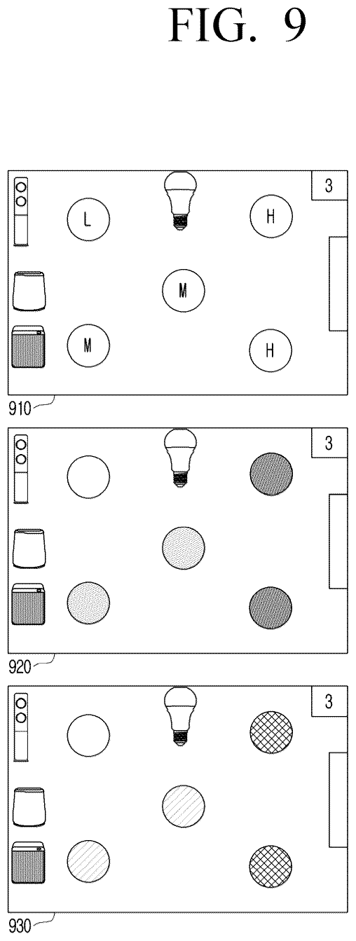

The driving map will be explained in FIG. 7. The sensing map will be explained in FIG. 8 to FIG. 9.

The at least one processor 111 may obtain signal data indicating signal strength of an access point (AP) device 400 connected with an IoT device while driving based on a moving path. The at least one processor 111 may generate a sensing map by applying the sensing data and the signal data to the driving map.

The AP device 400 may be a device for communicating with an IoT device 300. Also, the AP device 400 may be a device for managing a plurality of devices. The AP device 400 may also be described as a host device.

As an example, the electronic apparatus 100 may transmit a control command to the IoT device 300 through the AP device 400. The AP device 400 may receive the control command from the electronic apparatus 100. The AP device 400 may transmit the control command received from the electronic apparatus 100 to the IoT device 300.

As an example, the electronic apparatus 100 may directly transmit a control command to the IoT device 300 not via the AP device 400.

The at least one processor 111 may obtain signal strength of the AP device 400 in a plurality of locations. The at least one processor 111 may sense the signal strength of the AP device 400 while driving on the moving path. The at least one processor 111 may sense a signal output from the AP device 400 through the communication interface 114. The at least one processor 111 may identify the signal strength of the AP device 400 based on the sensed signal data.

The at least one processor 111 may generate a sensing map based on the sensing data and the signal data obtained in the plurality of locations.

As an example, the at least one processor 111 may generate a sensing map by using the sensing data and the signal data simultaneously.

As an example, the at least one processor 111 may generate a first sensing map by using the sensing data. Also, the at least one processor 111 may generate a second sensing map by applying the signal data to the first sensing map.

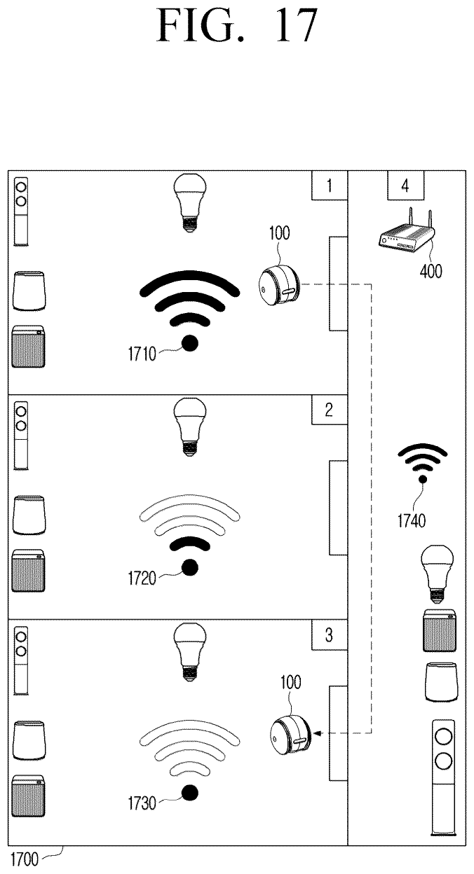

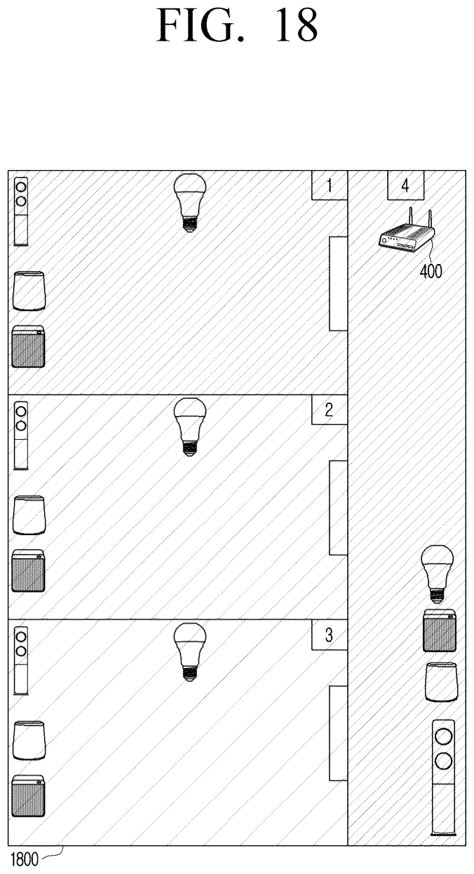

Sensing maps related to the signal strength of the AP device 400 will be described in FIG. 17 and FIG. 18.

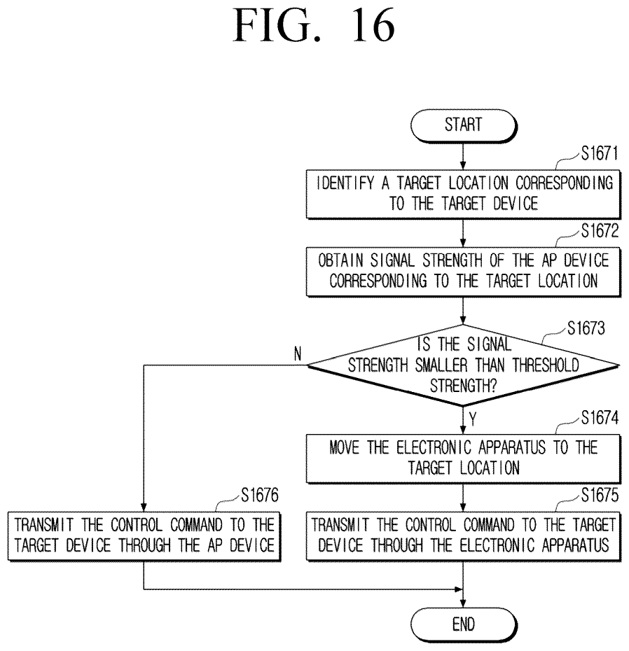

If a target area is determined, the at least one processor 111 may obtain signal strength corresponding to the location of the target area. If the signal strength is greater than or equal to a threshold strength, the at least one processor 111 may transmit a control command to a target device through the AP device 400. If the signal strength is smaller than the threshold strength, the at least one processor 111 may move to the target location, and directly transmit a control command to the target device. Explanation related to this will be described in FIG. 16.

The sensing map may include at least one environment UI indicating a sensing value included in the sensing data.

The sensing value may be a value indicating measurement data related to an environment. The sensing value may include different units according to the type of the sensing data.

The environment UI may be a UI for indicating a sensing value. The at least one processor 111 may identify a predetermined group corresponding to the sensing value. The at least one processor 111 may generate an environment UI corresponding to the identified group. The at least one processor 111 may generate a sensing map including the environment UI.

The form of the environment UI may be determined based on the type of the sensing data and the sensing value. Explanation related to the environment UI will be described in FIG. 8 to FIG. 12.

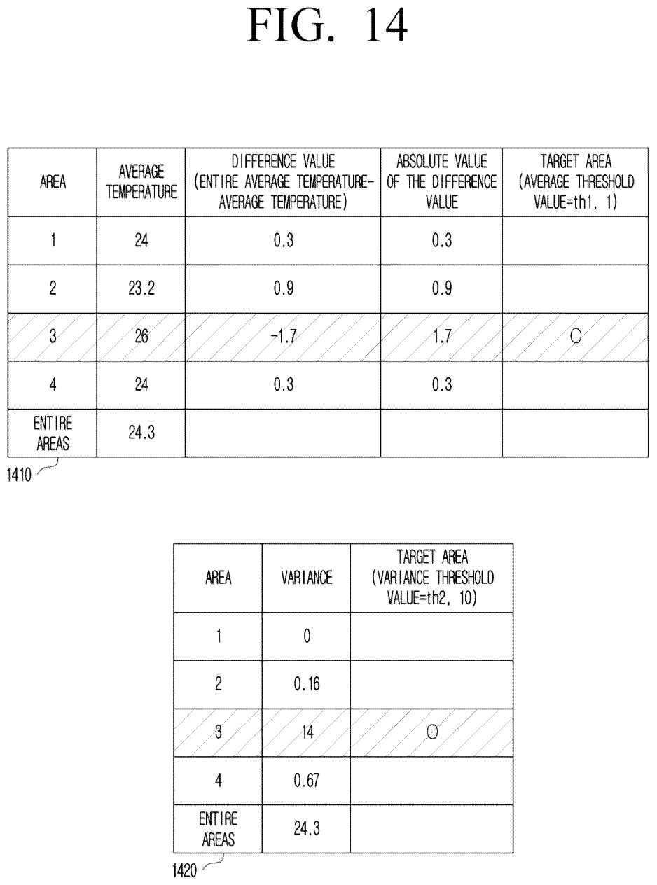

The at least one processor 111 may obtain a plurality of representative sensing values indicating each of a plurality of areas included in the sensing map. The at least one processor 111 may obtain an average sensing value of the plurality of representative sensing values. The at least one processor 111 may determine an area wherein a difference value between the representative sensing value and the average sensing value is greater than or equal to a threshold value as the target area. The threshold value may be changed according to the user's setting. Explanation related to this will be described in FIG. 14.

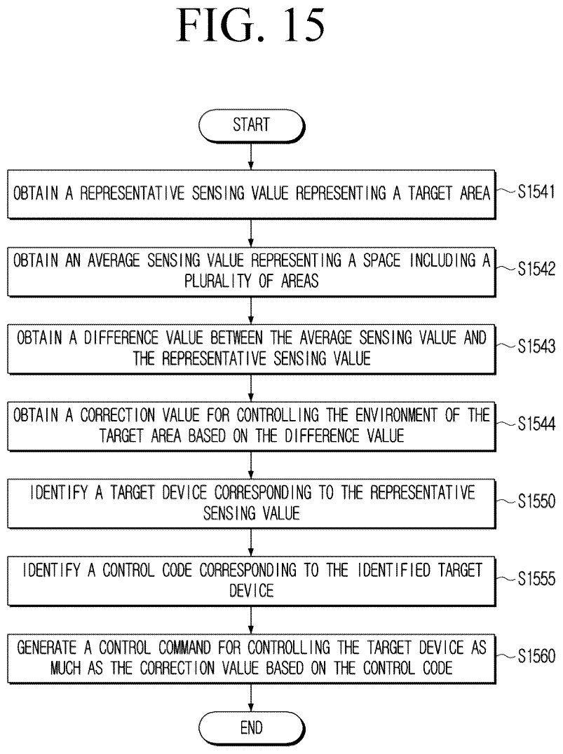

The at least one processor 111 may obtain a correction value for controlling the environment of the target area based on the difference value. The at least one processor 111 may generate a control command based on a control code corresponding to the identified target device and the correction value. Explanation related to this will be described in FIG. 15.

According to one or more embodiments, the electronic apparatus 100 may obtain the first sensing data sensed through the sensor part 121. The electronic apparatus 100 may obtain the second sensing data sensed from a sensor part included in the IoT device 300. The electronic apparatus 100 may obtain a sensing map by comparing the first sensing data and the second sensing data. The first sensing data and the second sensing data may be data obtained in the same space. The first sensing data and the second sensing data may be compared based on the same category. For example, temperature data associated with the first sensing data may be compared with temperature data associated with the second sensing data.

As an example, the electronic apparatus 100 may obtain the first sensing data while driving in a first space. The electronic apparatus 100 may obtain the second sensing data obtained from the sensor part of the IoT device 300 while driving in the first space. The electronic apparatus 100 may compare the first sensing data and the second sensing data obtained in the same space.

According to one or more embodiments, the electronic apparatus 100 may obtain final sensing data based on the first sensing data and the second sensing data. The electronic apparatus 100 may obtain a sensing map based on the final sensing data. The final sensing data may indicate the average data.

According to one or more embodiments, the electronic apparatus 100 may analyze a difference value between the first sensing data and the second sensing data obtained in the same space. If the difference value between the first sensing data and the second sensing data is greater than or equal to a threshold value, the electronic apparatus 100 may additionally obtain sensing data for the space. If the difference value is greater than or equal to the threshold value, the electronic apparatus 100 may determine that the accuracy of the sensing data is low. The electronic apparatus 100 may obtain new sensing data.

According to one or more embodiments, the electronic apparatus 100 may obtain the second sensing data from the IoT device 300 arranged in the first space. The electronic apparatus 100 may obtain the first sensing data through the sensor part 121 for the second space which is the remaining space excluding the first space. The electronic apparatus 100 may obtain a sensing map for all the spaces by using both of the first sensing data and the second sensing data.

According to one or more embodiments, the electronic apparatus 100 may use an artificial intelligence model for an operation of generating a sensing map based on a driving map and sensing data. The artificial intelligence model may be a model that was trained to output a sensing map. The electronic apparatus 100 may input a driving map and sensing data into the artificial intelligence model as input data. The artificial intelligence model may output a sensing map corresponding to the input data.

As an example, the artificial intelligence model may be stored in the electronic apparatus 100.

As an example, the artificial intelligence model may be stored in a server 200. The electronic apparatus 100 may transmit a driving map and sensing data to the server 200. The server 200 may generate a sensing map based on the artificial intelligence model. The server 200 may transmit the sensing map to the electronic apparatus 100.

An artificial intelligence system is a computer system implementing intelligence of a human level and is a system wherein a machine learns and determines by itself, and which shows a more improved recognition rate as it is used more.

An artificial intelligence technology consists of machine learning (deep learning) technologies using an algorithm of classifying/learning the characteristics of input data by itself, and element technologies of simulating functions of a human brain such as cognition, determination, etc. by utilizing a machine learning algorithm.

Element technologies may include, for example, at least one of a linguistic understanding technology of recognizing languages/characters of humans, a visual understanding technology of recognizing an object in a similar manner to human vision, an inference/prediction technology of judging information and then making logical inference and prediction, a knowledge representation technology of processing information of human experiences into knowledge data, or an operation control technology of controlling autonomous driving of vehicles and movements of robots.

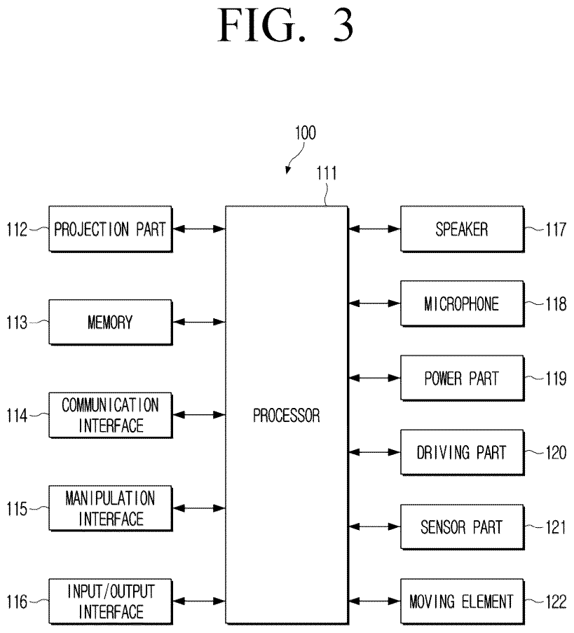

FIG. 3 is a block diagram for illustrating a detailed configuration of the electronic apparatus 100 in FIG. 2 according to one or more embodiments.

Referring to FIG. 3, the electronic apparatus 100 may include at least one of at least one processor 111, a projection part 112, memory 113, a communication interface 114, a manipulation interface 115, an input/output interface 116, a speaker 117, a microphone 118, a power part 119, a driving part 120, a sensor part 121, or a moving element 122.

Meanwhile, the components illustrated in FIG. 3 are merely one of various embodiments, and some components may be omitted, or new components may be added. Also, the content already explained in FIG. 2 will be omitted.

The at least one processor 111 may be implemented as a digital signal processor (DSP) processing digital signals, a microprocessor, and a time controller (TCON). However, the disclosure is not limited thereto, and the at least one processor 111 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the at least one processor 111 may be implemented as a system on chip (SoC) having a processing algorithm stored therein or large scale integration (LSI), or in the form of a field programmable gate array (FPGA). The at least one processor 111 may perform various functions by executing computer executable instructions stored in the memory 113.

The projection part 112 is a component that projects an image to the outside. The projection part 112 according to the various embodiments of the disclosure may be implemented by various projection methods (e.g., a cathode-ray tube (CRT) method, a liquid crystal display (LCD) method, a digital light processing (DLP) method, a laser method, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into a one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method, and in the case of the three-plate method, a light output from a light source may be divided into red, green, and blue colors in a dichroic mirror (a mirror that reflects only lights of specific colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a special mirror are used. The galvanometer includes a mirror and a motor of a high output, and moves the mirror at a fast speed. For example, the galvanometer may rotate the mirror at 40 KHz/sec at the maximum. The galvanometer is mounted according to a scanning direction, and in general, a projector performs plane scanning, and thus the galvanometer may also be arranged while being divided into x- and y-axes.

The projection part 112 may include various types of light sources. For example, the projection part 112 may include at least one light source among a lamp, LEDs, and laser.

The projection part 112 may output an image in a screen ratio of 4:3, a screen ratio of 5:4, and a wide screen ratio of 16:9 according to the use of the electronic apparatus 100 or the user's setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc., according to screen ratios.

The projection part 112 may perform various functions for adjusting an output image by control by the at least one processor 111. For example, the projection part 112 may perform functions such as zoom, keystone, quick corner (four corner) keystone, lens shift, etc.

Specifically, the projection part 112 may enlarge or reduce an image according to a distance from a screen (a projection distance). That is, a zoom function may be performed according to a distance from a screen. Here, the zoom function may include a hardware method of adjusting the size of a screen by moving a lens and a software method of adjusting the size of a screen by cropping an image, etc. When the zoom function is performed, adjustment of a focus of an image is needed. For example, methods of adjusting a focus include a manual focus method, an electric method, etc. The manual focus method means a method of adjusting a focus manually, and the electric method means a method wherein, when the zoom function is performed, the projector automatically adjusts a focus by using a built-in motor. When performing the zoom function, the projection part 112 may provide a digital zoom function through software, and also provide an optical zoom function of performing a zoom function by moving the lens through the driving part 120.

The projection part 112 may perform a keystone correction function. A screen may be distorted in an upper direction or a lower direction if the height is not matched in the front surface projection. The keystone correction function means a function of correcting a distorted screen. For example, if a distortion occurs in a left-right direction of a screen, the screen may be corrected by using horizontal keystone, and if a distortion occurs in an up-down direction, the screen may be corrected by using vertical keystone. The quick corner (four corner) keystone correction function is a function of correcting a screen in case the central area of the screen is normal, but the corner areas are out of balance. The lens shift function is a function of moving a screen as it is in case the screen is beyond the range of the screen.

The projection part 112 may analyze the ambient environment and a projection environment automatically without a user input, and provide zoom/keystone/focus functions. Specifically, the projection part 112 may provide zoom/keystone/focus functions automatically based on the distance between the electronic apparatus 100 and the screen detected through the sensor (the depth camera, the distance sensor, the infrared sensor, the illumination sensor, etc.), information on the space wherein the electronic apparatus 100 is currently located, information on the ambient light amount, etc.

The projection part 112 may provide an illumination function by using a light source. In particular, the projection part 112 may provide an illumination function by outputting a light source by using a light-emitting diode (LED). According to various embodiments, the projection part 112 may include one LED, and according to another embodiment, the electronic apparatus 100 may include a plurality of LEDs. Meanwhile, the projection part 112 may output a light source by using a surface emitting LED depending on implementation examples. Here, a surface emitting LED may mean an LED having a structure wherein an optical sheet is arranged on the upper side of the LED such that a light source is evenly dispersed and output. Specifically, if a light source is output through an LED, the light source may be evenly dispersed through an optical sheet, and the light source dispersed through the optical sheet may be incident on a display panel.

The projection part 112 may provide a dimming function for adjusting the strength of a light source to the user. Specifically, if a user input for adjusting the strength of a light source is received from the user through the manipulation interface 115 (e.g., a touch display button or a dial), the projection part 112 may control the LED to output the strength of the light source corresponding to the received user input.

The projection part 112 may provide the dimming function based on a content analyzed by the at least one processor 111 without a user input. Specifically, the projection part 112 may control the LED to output the strength of a light source based on information on the currently provided content (e.g., the content type, the content brightness, etc.).

The projection part 112 may control the color temperature according to the at least one processor 111. The at least one processor 111 may control the color temperature based on a content. Specifically, if it is identified that a content is to be output, the at least one processor 111 may obtain the color information for each frame of the content of which output has been determined. Then, the at least one processor 111 may adjust the color temperature based on the obtained color information for each frame. The at least one processor 111 may obtain at least one main color of the frames based on the color information for each frame. Then, the at least one processor 111 may adjust the color temperature based on the obtained at least one main color. For example, the color temperature that can be adjusted by the at least one processor 111 may be divided into a warm type or a cold type. It is assumed that a frame to be output (referred to as an output frame hereinafter) includes a scene wherein fire broke out. The at least one processor 111 may identify (or obtain) that the main color is a red color based on the color information included in the current output frame. Then, the at least one processor 111 may identify a color temperature corresponding to the identified main color (e.g., red). The color temperature corresponding to the red color may be the warm type. The at least one processor 111 may use an artificial intelligence model for obtaining the color information or the main color of a frame. According to various embodiments, the artificial intelligence model may be stored in the electronic apparatus 100 (e.g., the memory 113). According to another embodiment, the artificial intelligence model may be stored in an external server that can communicate with the electronic apparatus 100.

The memory 113 may be implemented as internal memory such as ROM (e.g., electrically erasable programmable read-only memory (EEPROM)), RAM, etc., included in the at least one processor 111, or implemented as separate memory from the at least one processor 111. In this case, the memory 113 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g., dynamic RAM (DRAM), static RAM (SRAM), or synchronous dynamic RAM (SDRAM), etc.) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)). Meanwhile, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

In the memory 113, at least one instruction regarding the electronic apparatus 100 may be stored. Also, in the memory 113, an operating system (O/S) for operating the electronic apparatus 100 may be stored. In addition, in the memory 113, various types of software programs or applications for making the electronic apparatus 100 operate according to the various embodiments of the disclosure may be stored. Further, the memory 113 may include semiconductor memory such as flash memory, or a magnetic storage medium such as a hard disk, but is not limited thereto.

Specifically, various types of software modules for the electronic apparatus 100 to operate according to the various embodiments of the disclosure may be stored, and the at least one processor 111 may control the operations of the electronic apparatus 100 by executing the various types of software modules stored in the memory 113. That is, the memory 113 may be accessed by the at least one processor 111, and reading/recording/correction/deletion/update, etc. of data by the at least one processor 111 may be performed.

In the disclosure, the term ‘memory 113’ may be used as meaning including a storage part, ROM or RAM inside the at least one processor 111, or a memory card (e.g., a micro SD card, a memory stick) installed on the electronic apparatus 100.

The communication interface 114 is a component that performs communication with various types of external devices according to various types of communication methods. The communication interface 114 may include a wireless communication module or a wired communication module. Each communication module may be implemented in a form of at least one hardware chip.

A wireless communication module may be a module that communicates with an external device wirelessly. For example, a wireless communication module may include at least one module among a Wi-Fi module, a Bluetooth module, an infrared communication module, but is not limited thereto and may include other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external device via wire. For example, a wired communication module may include at least one of a local area network (LAN) module, an Ethernet module, a pair cable, a coaxial cable, an optical fiber cable, or an ultra-wide-band (UWB) module.

The manipulation interface 115 may include various types of input devices. For example, the manipulation interface 115 may include physical buttons. Here, the physical buttons may include function keys, direction keys (e.g., four direction keys), or dial buttons. According to various embodiments, the physical buttons may be implemented as a plurality of keys. According to another embodiment, the physical buttons may be implemented as one key. In the event the physical buttons are implemented as one key, the electronic apparatus 100 may receive a user input by which one key is pushed during a threshold time or longer. If a user input by which one key is pushed during a threshold time or longer is received, the at least one processor 111 may perform a function corresponding to the user input. For example, the at least one processor 111 may provide an illumination function based on the user input.

The manipulation interface 115 may receive a user input by using a non-contact method. In the case of receiving a user input through a contact method, physical force should be transmitted to the electronic apparatus 100. Accordingly, a method for controlling the electronic apparatus 100 regardless of physical force may be needed. Specifically, the manipulation interface 115 may receive a user gesture, and perform an operation corresponding to the received user gesture. The manipulation interface 115 may receive a user's gesture through a sensor (e.g., an image sensor or an infrared sensor).

The manipulation interface 115 may receive a user input by using a touch method. For example, the manipulation interface 115 may receive a user input through a touch sensor. According to various embodiments, the touch method may be implemented as a non-contact method. For example, the touch sensor may determine whether the user's body approached within a threshold distance. The touch sensor may identify a user input even when the user does not contact the touch sensor. According to another implementation example, the touch sensor may identify a user input by which the user contacts the touch sensor.

The electronic apparatus 100 may receive a user input by various methods other than the aforementioned manipulation interface 115. According to various embodiments, the electronic apparatus 100 may receive a user input through an external remote control device. The external remote control device may be a remote control device corresponding to the electronic apparatus 100 (e.g., a dedicated control device of the electronic apparatus 100) or the user's portable communication device (e.g., a smartphone or a wearable device). In the user's portable communication device, an application for controlling the electronic apparatus 100 may be stored. The portable communication device may obtain a user input through a stored application, and transmit the obtained user input to the electronic apparatus 100. The electronic apparatus 100 may receive a user input from the portable communication device, and perform an operation corresponding to a control command of the user.

The electronic apparatus 100 may receive a user input by using voice recognition. According to various embodiments, the electronic apparatus 100 may receive a user voice through the microphone included in the electronic apparatus 100. According to another embodiment, the electronic apparatus 100 may receive a user voice from the microphone or an external device. Specifically, an external device may obtain a user voice through a microphone of the external device, and transmit the obtained user voice to the electronic apparatus 100. A user voice transmitted from the external device may be audio data or digital data converted from audio data (e.g., audio data converted to a frequency domain, etc.). The electronic apparatus 100 may perform an operation corresponding to the received user voice. Specifically, the electronic apparatus 100 may receive audio data corresponding to the user voice through the microphone. Then, the electronic apparatus 100 may convert the received audio data into digital data. Then, the electronic apparatus 100 may convert the converted digital data into text data by using a speech to text (STT) function. According to various embodiments, the speech to text (STT) function may be directly performed at the electronic apparatus 100.

According to another embodiment, the speech to text (STT) function may be performed at an external server. The electronic apparatus 100 may transmit digital data to the external server. The external server may convert the digital data into text data, and obtain control command data based on the converted text data. The external server may transmit the control command data (here, the text data may also be included) to the electronic apparatus 100. The electronic apparatus 100 may perform an operation corresponding to the user voice based on the obtained control command data.

The electronic apparatus 100 may provide a voice recognition function by using one assistance (or an artificial intelligence agent, e.g., Bixby™, etc.), but this is merely one of various examples, and the electronic apparatus 100 may provide the voice recognition function through a plurality of assistances. Here, the electronic apparatus 100 may provide the voice recognition function by selecting one of the plurality of assistances based on a trigger word corresponding to the assistance or a specific key existing on a remote control.

The electronic apparatus 100 may receive a user input by using a screen interaction. A screen interaction may mean a function by which the electronic apparatus 100 identifies whether a predetermined event occurs through an image projected on a screen (or a projection surface), and obtains a user input based on the predetermined event. The predetermined event may mean an event wherein a predetermined object is identified in a specific location (e.g., a location wherein a UI for receiving a user input was projected). The predetermined object may include at least one of a body part of the user (e.g., a finger), a pointer, or a laser point. If the predetermined object is identified in the location corresponding to the projected UI, the electronic apparatus 100 may identify that a user input selecting the projected UI was received. For example, the electronic apparatus 100 may project a guide image such that a UI is displayed on the screen. Then, the electronic apparatus 100 may identify whether the user selects the projected UI. Specifically, if the predetermined object is identified in the location of the projected UI, the electronic apparatus 100 may identify that the user selected the projected UI. The projected UI may include at least one item. The electronic apparatus 100 may perform space analysis for identifying whether the predetermined object is in the location of the projected UI. The electronic apparatus 100 may perform space analysis through the sensor (e.g., the image sensor, the infrared sensor, the depth camera, the distance sensor, etc.). The electronic apparatus 100 may identify whether the predetermined event occurs in the specific location (the location wherein the UI was projected) by performing space analysis. Then, if it is identified that the predetermined event occurs in the specific location (the location wherein the UI was projected), the electronic apparatus 100 may identify that a user input for selecting the UI corresponding to the specific location was received.

The input/output interface 116 is a component for inputting or outputting at least one of an audio signal or an image signal. The input/output interface 116 may receive input of at least one of an audio signal or an image signal from an external device, and output a control command to the external device.

Depending on implementation examples, the input/output interface 116 may be implemented as an interface inputting or outputting only audio signals and an interface inputting or outputting only image signals, or implemented as one interface inputting or outputting both audio signals and image signals.

The input/output interface 116 according to the various embodiments of the disclosure may be implemented as at least one wired input/output interface among a high definition multimedia interface (HDMI), a mobile high-definition link (MHL), a universal serial bus (USB), a USB C-type, a display port (DP), a Thunderbolt, a video graphics array (VGA) port, an RGB port, a D-subminiature (D-SUB), and a digital visual interface (DVI), but is not limited thereto. According to the various embodiments, the wired input/output interface may be implemented as an interface inputting or outputting only audio signals and an interface inputting or outputting only image signals, or implemented as one interface inputting or outputting both audio signals and image signals.

The electronic apparatus 100 may receive data through a wired input/output interface, but this is merely one of various embodiments, and the electronic apparatus 100 may be supplied with power through a wired input/output interface. For example, the electronic apparatus 100 may be supplied with power from an external battery through a USB C-type, or may be supplied with power from a consent through a power adapter. As another example, the electronic apparatus 100 may be supplied with power from an external device (e.g., a laptop or a monitor, etc.) through a DP.

The electronic apparatus 100 may be implemented such that an audio signal is input through a wired input/output interface, and an image signal is input through a wireless input/output interface (or a communication interface). Alternatively, the electronic apparatus 100 may be implemented such that an audio signal is input through a wireless input/output interface (or a communication interface), and an image signal is input through a wired input/output interface.

The speaker 117 is a component that outputs audio signals. In particular, the speaker 117 may include an audio output mixer, an audio signal processor, and an audio output module. The audio output mixer may synthesize a plurality of audio signals to be output into at least one audio signal. For example, the audio output mixer may synthesize an analog audio signal and another analog audio signal (e.g., an analog audio signal received from the outside) into at least one analog audio signal. The audio output module may include a speaker or an output terminal. According to various embodiments, the audio output module may include a plurality of speakers, and in this case, the audio output module may be arranged inside the main body, and audio that is emitted while covering at least a portion of the diaphragm of the audio output module may pass through a waveguide, and may be transmitted to the outside of the main body. The audio output module may include a plurality of audio output units, and as the plurality of audio output units are symmetrically arranged on the exterior of the main body, audio may be emitted in all directions, that is, all directions in 360 degrees.

The microphone 118 is a component for receiving input of a user voice or other sounds, and converting them into audio data. The microphone 118 may receive a user's voice in an activated state. For example, the microphone 118 may be formed as an integrated type on the upper side or the front surface direction, the side surface direction, etc., of the electronic apparatus 100. The microphone 118 may include various components such as a microphone collecting a user voice in an analog form, an amp circuit amplifying the collected user voice, an A/D conversion circuit that samples the amplified user voice and converts the user voice into a digital signal, a filter circuit that removes noise components from the converted digital signal, but is not limited thereto.

The power part 119 may be supplied with power from the outside, and supply power to the various components of the electronic apparatus 100. The power part 119 according to the various embodiments of the disclosure may be supplied with power through various methods. According to the various embodiments, the power part 119 may be supplied with power by using a connector 130 as illustrated in FIG. 1. Also, the power part 119 may be supplied with power by using a direct current (DC) power code of 220V. However, the disclosure is not limited thereto, and the electronic apparatus 100 may be supplied with power by using a USB power code, or supplied with power by using a wireless charging method.

The power part 119 may be supplied with power by using an internal battery or an external battery. The power part 119 according to the various embodiments of the disclosure may be supplied with power through an internal battery. As an example, the power part 119 may charge the power of the internal battery by using at least one of a DC power code of 220V, a USB power code, or a USB C-type power code, and may be supplied with power through the charged internal battery. The power part 119 according to the various embodiments of the disclosure may be supplied with power through an external battery. As an example, if connection between the electronic apparatus 100 and the external battery is performed through various wired communication methods such as a USB power code, a USB C-type power code, a socket groove, or similar, and the power part 119 may be supplied with power through the external battery. That is, the power part 119 may be directly supplied with power from the external battery, or charge the internal battery through the external battery, and may be supplied with power from the charged internal battery.

The power part 119 according to the disclosure may be supplied with power by using at least one of the aforementioned plurality of power supply methods.

With respect to power consumption, the electronic apparatus 100 may have power consumption lower than or equal to a predetermined value (e.g., 43 W) for reasons such as a socket form and other standards, but is not limited thereto. Here, the electronic apparatus 100 may vary the power consumption so that power consumption can be reduced when using the battery. That is, the electronic apparatus 100 may vary the power consumption based on a power supply method and a power use amount, but is not limited thereto.

The driver 120 may drive at least one hardware component included in the electronic apparatus 100. The driver 120 may generate physical force, and transmit the force to at least one hardware component included in the electronic apparatus 100.

The driver 120 may generate driving power for an operation of moving a hardware component included in the electronic apparatus 100 (e.g., moving of the electronic apparatus 100) or rotating a component (e.g., rotating of the projection lens).

The driver 120 may adjust the projection angle of the projection part 112. The driver 120 may move the location of the electronic apparatus 100. The driver 120 may control the moving element for moving the electronic apparatus 100. For example, the driver 120 may control the moving element by using the motor.

The sensor part 121 may include at least one sensor. Specifically, the sensor part 121 may include a tilt sensor that senses a tilt of the electronic apparatus 100 or an image sensor that photographs an image. The tilt sensor may be an acceleration sensor or a gyro sensor, and the image sensor may mean a camera or a depth camera. The tilt sensor may also be described as a motion sensor. The sensor part 121 may include various sensors other than the tilt sensor or the image sensor. For example, the sensor part 121 may include an illumination sensor and a distance sensor. The distance sensor may be a time of flight (ToF) sensor. Also, the sensor part 121 may include a LiDAR sensor.

The electronic apparatus 100 may control the illumination function by being interlocked with an external device. Specifically, the electronic apparatus 100 may receive illumination information from an external device. The illumination information may include at least one of brightness information or color temperature information set in the external device. The external device may mean a device connected to the same network as the electronic apparatus 100 (e.g., an IoT device included in the same home/company network) or a device that is not connected to the same network as the electronic apparatus 100 but can communicate with the electronic apparatus 100 (e.g., a remote control server). For example, it is assumed that an external illumination device (an IoT device) included in the same network as the electronic apparatus 100 is outputting a red lighting at a brightness of 50. The external illumination device (an IoT device) may directly or indirectly transmit illumination information (e.g., information that the red lighting is being output at the brightness of 50) to the electronic apparatus 100. The electronic apparatus 100 may control an output of a light source based on the illumination information received from the external illumination device. For example, if the illumination information received from the external illumination device includes information that the red lighting is being output at the brightness of 50, the electronic apparatus 100 may output the red lighting at the brightness of 50.

Also, the electronic apparatus 100 may control the illumination function based on biometric information. Specifically, the at least one processor 111 may obtain the biometric information of the user. The biometric information may include at least one of the body temperature, the heart rate, the blood pressure, the breathing, or the electrocardiogram of the user, but is not limited thereto. The biometric information may include various kinds of information other than the aforementioned information. As an example, the electronic apparatus 100 may include a sensor for measuring biometric information. The at least one processor 111 may obtain the biometric information of the user through the sensor, and control an output of a light source based on the obtained biometric information. As another example, the at least one processor 111 may receive biometric information from an external device through the input/output interface 116. The external device may mean a portable communication device (e.g., a smartphone or a wearable device) of the user. The at least one processor 111 may obtain the biometric information of the user from the external device, and control an output of a light source based on the obtained biometric information. Depending on implementation examples, the electronic apparatus 100 may identify whether the user is sleeping, and if it is identified that the user is sleeping (or is preparing to sleep), the at least one processor 111 may control an output of a light source based on the biometric information of the user.

The electronic apparatus 100 according to the various embodiments of the disclosure may provide various smart functions.

Specifically, the electronic apparatus 100 may be connected with a portable terminal device for controlling the electronic apparatus 100, and the screen output from the electronic apparatus 100 may be controlled through a user input that is input into the portable terminal device. As an example, the portable terminal device may be implemented as a smartphone including a touch display, and the electronic apparatus 100 may receive screen data provided at the portable terminal device from the portable terminal device and output the screen, and the screen output from the electronic apparatus 100 may be controlled according to a user input that is input into the portable terminal device.

The electronic apparatus 100 may perform connection with a portable terminal device through various communication methods such as Miracast, Airplay, wireless DeX, a remote PC method, or similar, and share contents or music provided at the portable terminal device.

Also, connection between a portable terminal device and the electronic apparatus 100 may be performed by various connection methods. According to various embodiments, a portable terminal device may search the electronic apparatus 100 and perform wireless connection, or the electronic apparatus 100 may search the portable terminal device and perform wireless connection. Then, the electronic apparatus 100 may output contents provided at the portable terminal device.

According to various embodiments, while a specific content or music is being output at a portable terminal device, if the portable terminal device is located near the electronic apparatus 100, and then a predetermined gesture (e.g., a motion tap view) is detected through the display of the portable terminal device, the electronic apparatus 100 may output the content or the music that is being output at the portable terminal device.

Also, according to various embodiments, while a specific content or music is being output at a portable terminal device, if the portable terminal device becomes close to the electronic apparatus 100 within a predetermined distance or shorter (e.g., a non-contact tap view), or the portable terminal device contacts the electronic apparatus 100 at a short interval twice (e.g., a contact tap view), the electronic apparatus 100 may output the content or the music that is being output at the portable terminal device.

In the aforementioned embodiments, it was explained that the same screen as the screen that is being provided at a portable terminal device is provided at the electronic apparatus 100, but the disclosure is not limited thereto. That is, if connection between a portable terminal device and the electronic apparatus 100 is constructed, a first screen provided at the portable terminal device may be output at the portable terminal device, and a second screen provided at the portable terminal device different from the first screen may be output at the electronic apparatus 100. As an example, the first screen may be a screen provided by a first application installed in the portable terminal device, and the second screen may be a screen provided by a second application installed in the portable terminal device. As an example, the first screen and the second screen may be different screens provided by one application installed in the portable terminal device. As an example, the first screen may be a screen including a UI in a remote control format for controlling the second screen.

The electronic apparatus 100 according to the disclosure may output a standby screen. As an example, in case connection of the electronic apparatus 100 with an external device was not performed or there is no input received from the external device during a predetermined time, the electronic apparatus 100 may output a standby screen. Conditions for the electronic apparatus 100 to output a standby screen are not limited to the aforementioned example, and a standby screen may be output by various conditions.

Also, the electronic apparatus 100 may output a standby screen in a form of a blue screen, but the disclosure is not limited thereto. As an example, the electronic apparatus 100 may extract only a form of a specific object from data received from an external device and obtain an atypical object, and output a standby screen including the obtained atypical object.

The electronic apparatus 100 may further include a display.

The display may be implemented as displays in various forms such as a liquid crystal display (LCD), an organic light emitting diodes (OLED) display, a plasma display panel (PDP), etc. Inside the display, a driving circuit that may be implemented in forms such as an amorphous silicon thin film transistor (a-si) TFT, a low temperature poly silicon (LTPS) TFT, an organic TFT (OTFT), or similar, and a backlight unit may also be included together. The display may be implemented as a touch screen combined with a touch sensor, a flexible display, a three-dimensional (3D) display, etc. Also, the display according to the various embodiments of the disclosure may include not only a display panel outputting images, but also a bezel housing the display panel. In particular, a bezel according to the various embodiments of the disclosure may include a touch sensor for detecting user interactions.

The electronic apparatus 100 may further include a shutter part.

The shutter part may include at least one of a shutter, a fixing element, a rail, or a body.

The shutter may block light output from the projection part 112. The fixing element may fix the location of the shutter. The rail may be a route through which the shutter and the fixing element are moved. The body may be a component including the shutter and the fixing element.

The moving element 122 may mean an element for the electronic apparatus 100 to move from the first location to the second location in the space wherein the electronic apparatus 100 is located. The electronic apparatus 100 may control the moving element 122 such that the electronic apparatus 100 is moved by using the force generated in the driving part 120. The electronic apparatus 100 may generate force to be transmitted to the moving element 122 by using the motor included in the driving part 120.

The moving element 122 may include at least one wheel (e.g., a circular wheel). The electronic apparatus 100 may move to a target location (or destination location) through the moving element. When a user input or a control command is received, the electronic apparatus 100 may rotate the moving element 122 by transmitting the force generated through the motor to the moving element 122. The electronic apparatus 100 may control the moving element 122 for adjusting the rotation speed, the rotation direction, etc. The electronic apparatus 100 may perform a moving operation (or a moving function) by controlling the moving element 122 based on the target location or the proceeding direction, etc.

There may be various embodiments wherein the electronic apparatus 100 performs an operation corresponding to a user voice signal received through the microphone 118.

According to one or more embodiments, the electronic apparatus 100 may control the display based on a user voice signal received through the microphone 118. For example, if a user voice signal for displaying an “A” content is received, the electronic apparatus 100 may control the display to display the A content.

According to one or more embodiments, the electronic apparatus 100 may control an external display device connected with the electronic apparatus 100 based on a user voice signal received through the microphone 118. Specifically, the electronic apparatus 100 may generate a control signal for controlling the external display device such that an operation corresponding to a user voice signal is performed in the external display device, and transmit the generated control signal to the external display device. Here, the electronic apparatus 100 may store a remote control application for controlling the external display device. Also, the electronic apparatus 100 may transmit the generated control signal to the external display device by using at least one communication method among Bluetooth, Wi-Fi, or infrared rays. For example, if a user voice signal for displaying the A content is received, the electronic apparatus 100 may transmit a control signal for controlling such that the A content is displayed on the external display device to the external display device. Here, the electronic apparatus 100 may mean various terminal devices wherein a remote control application can be installed such as a smartphone, an AI speaker, or the like, but is not limited thereto.

According to one or more embodiments, the electronic apparatus 100 may use a remote control device for controlling the external display device connected with the electronic apparatus 100 based on a user voice signal received through the microphone 118. Specifically, the electronic apparatus 100 may transmit a control signal for controlling the external display device such that an operation corresponding to a user voice signal is performed in the external display device to the remote control device. Then, the remote control device may transmit the control signal received from the electronic apparatus 100 to the external display device. For example, if a user voice signal for displaying the A content is received, the electronic apparatus 100 may transmit a control signal for controlling such that the A content is displayed on the external display device to the remote control device, and the remote control device may transmit the received control signal to the external display device.

According to one or more embodiments, the communication interface 114 may use the same communication module (e.g., a Wi-Fi module) for communicating with an external device such as a remote control device and an external server.

According to one or more embodiments, the communication interface 114 may use different communication modules for communicating with an external device such as a remote control device and an external server. For example, the communication interface 114 may use at least one of an Ethernet module or a Wi-Fi module for communicating with an external server, or use a Bluetooth module for communicating with an external device such as a remote control device, but is not limited thereto. For example, the communication interface 114 may use at least one communication module among various communication modules in the case of communicating with a plurality of external devices or external servers.

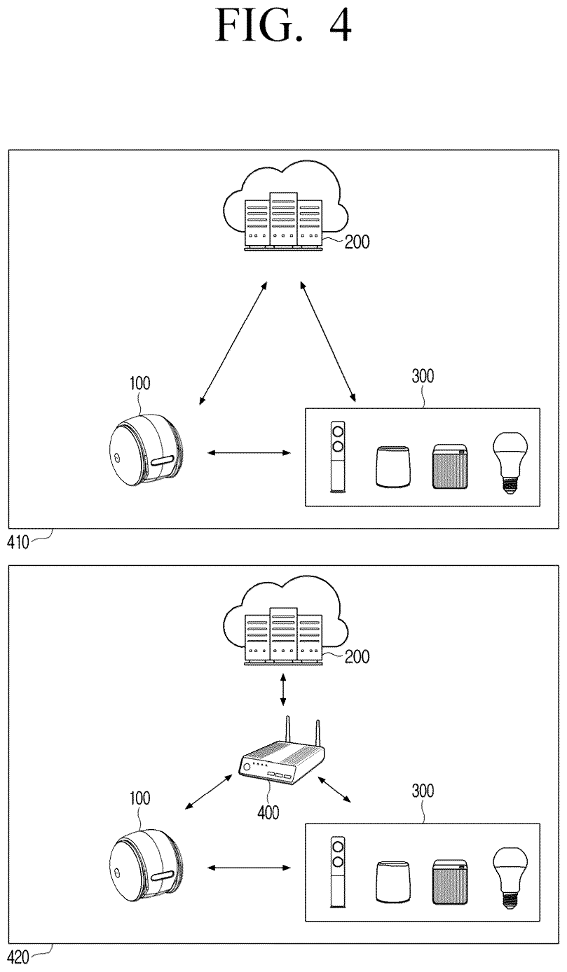

FIG. 4 is a diagram for illustrating an operation of the electronic apparatus 100 of communicating with an external device according to one or more embodiments.

Referring to the embodiment 410 in FIG. 4, the electronic apparatus 100 may be communicatively connected with the server 200. Also, the electronic apparatus 100 may be communicatively connected with the IoT device 300. The electronic apparatus 100 may transmit various types of information processed at the electronic apparatus 100 to the server 200 or the IoT device 300. The server 200 may be communicatively connected with the electronic apparatus 100 or the IoT device 300. The server 200 may be a management server for controlling a device located in a specific space. The server 200 may be described as an IoT server or a cloud server. The IoT device 300 may indicate various home appliances connected with the server 200. As an example, the IoT device 300 may include at least one of an air conditioner, a humidifier, an air purifier, or a smart bulb.

As an example, the electronic apparatus 100 may be connected with a data network by itself. The electronic apparatus 100 may be connected with the server 200 through the data network. The electronic apparatus 100 may transmit a control command to the IoT device 300 through the server 200.

Referring to the embodiment 420 in FIG. 4, the server 200 may be communicatively connected with the electronic apparatus 100 or the IoT device 300 through the access point (AP) device 400. The AP device 400 may connect the server 200 and various devices 100, 300 arranged in the space. As an example, the AP device 400 may be described as a router.

According to another embodiment, the IoT device 300 may not be directly registered at the server 200. A device not equipped with a wireless communication function may exist. The electronic apparatus 100 may obtain a photographed image through driving. The electronic apparatus 100 may identify the IoT device 300 not registered at the server 200 based on the photographed image. If the IoT device 300 was identified in the photographed image but the IoT device 300 is not identified on the map, the electronic apparatus 100 may determine that the IoT device 300 is not a device registered at the server 200. If the IoT device 300 not registered at the server 200 is identified, the electronic apparatus 100 may control the IoT device 300 by generating a control signal (e.g., an infrared remote control signal) corresponding to the IoT device 300.

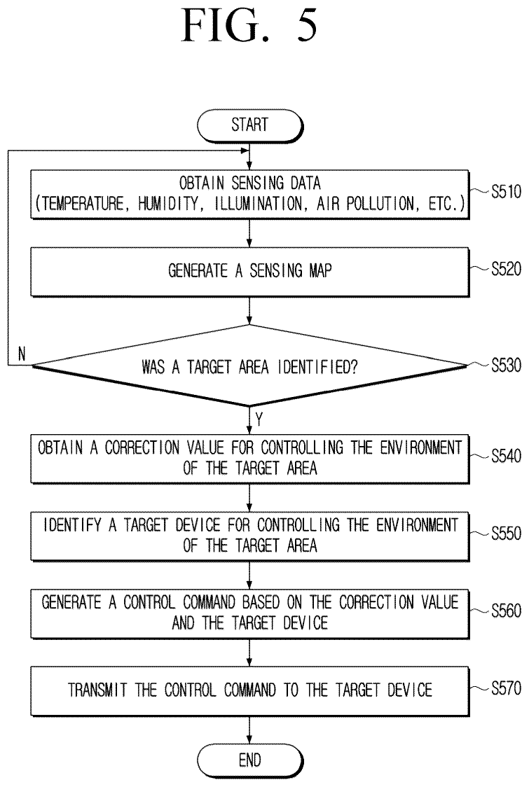

FIG. 5 is a diagram for illustrating an operation of transmitting a control command to a target device according to one or more embodiments.

Referring to FIG. 5, the electronic apparatus 100 may obtain sensing data in the step S510. The sensing data may include data related to at least one of a temperature, humidity, illumination, air pollution, or ozone. The electronic apparatus 100 may obtain sensing data through the sensor part 121. The sensor part 121 may include at least one sensor. As an example, the sensor part 121 may include at least one of a temperature sensor, a humidity sensor, an illumination sensor, an air pollution sensor, or an ozone sensor.

The sensing data may also be described as environment data.

The air pollution may include at least one of chemical pollution or particulate pollution. The chemical pollution may indicate the degree that chemical gas (or fume) is included in the air. The particulate pollution may indicate the degree that ultrafine dust or fine dust is included in the air.

The air pollution sensor may include at least one of a first air pollution sensor for measuring chemical pollution or a second air pollution sensor for measuring particulate pollution.

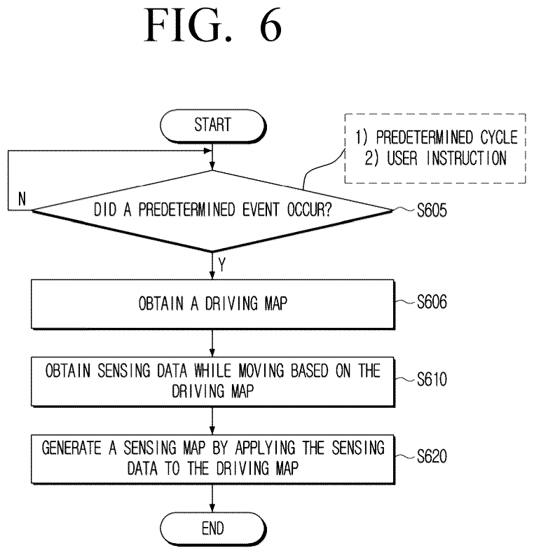

The electronic apparatus 100 may generate a sensing map based on the sensing data in the step S520. The sensing map may also be described as an environment map. The electronic apparatus 100 may generate a sensing map indicating the sensing data. The sensing map may include information for indicating an environment corresponding to a specific location (or a specific space). Explanation related to this will be described in FIG. 6 to FIG. 12.

The electronic apparatus 100 may identify whether a target area is identified in the step S530. The electronic apparatus 100 may identify a target area among a plurality of areas included in the sensing map.

The electronic apparatus 100 may determine a space wherein control is needed among the plurality of areas as the target area. The feature that control is needed may mean that the space is in a different environment compared to the other spaces. As an example, the target area may be an area wherein sensing values are higher compared to the other spaces or sensing values are not uniform. A sensing value may indicate a value that measured a subject for sensing in the sensing data. The sensing data may include the sensing values.

The electronic apparatus 100 may identify the plurality of areas in the sensing map. The electronic apparatus 100 may obtain representative sensing values for each of the plurality of areas. The electronic apparatus 100 may obtain an average sensing value for all of the plurality of areas. The electronic apparatus 100 may identify the target area by comparing the average sensing value and the representative sensing values.

As an example, the electronic apparatus 100 may determine an area wherein the representative sensing value is greater than or equal to a first threshold value as the target area.

As an example, the electronic apparatus 100 may determine an area wherein a difference value between the representative sensing value and the average sensing value is greater than or equal to a second threshold value (or smaller than or equal to a second threshold value) as the target area.

As an example, the electronic apparatus 100 may obtain an absolute value of a difference value between a representative sensing value and the average sensing value. The electronic apparatus 100 may determine an area wherein the absolute value is greater than or equal to a third threshold value as the target area.

If the target area is not identified in the step S530-N, the electronic apparatus 100 may repeatedly perform the steps S510, S520, and S530.

If the target area is identified in the step S530-Y, the electronic apparatus 100 may obtain a correction value for controlling the environment of the target area in the step S540. The electronic apparatus 100 may obtain a correction value for correcting the environment of the target area. As an example, the correction value may indicate a temperature change value. Also, the correction value may indicate the degree that a correction should be made in the currently detected environment.

As an example, it is assumed that the average temperature is 24.3 degrees, and the temperature of a specific space is 26 degrees. The electronic apparatus 100 may lower the temperature by −1.7 degrees for the specific space. The correction value may indicate −1.7.

The electronic apparatus 100 may identify a target device for controlling the environment of the target area in the step S550. The electronic apparatus 100 may identify the location of the IoT device 300 arranged in the space. When the target area is determined, the electronic apparatus 100 may identify IoT devices located in the target area. The electronic apparatus 100 may identify an IoT device for controlling the target area among a plurality of IoT devices existing in the target area as the target device. The electronic apparatus 100 may obtain identification information corresponding to the target device based on a predetermined IoT device list.

The electronic apparatus 100 may generate a control command based on the correction value and the target device in the step S560. The electronic apparatus 100 may generate a control command for controlling the target device as much as the correction value.

The electronic apparatus 100 may transmit the generated control command to the target device in the step S570. The electronic apparatus 100 may transmit the control command to the target device for controlling the target device. The target device may perform a function corresponding to the received control command.

In FIG. 5, an operation of generating a sensing map was disclosed. However, according to one or more embodiments, a target area may be determined without using a sensing map. The electronic apparatus 100 may determine a target area by using the sensing data. The electronic apparatus 100 may determine a target area by using a driving map and the sensing data.

FIG. 6 is a diagram for illustrating an operation of generating a sensing map according to one or more embodiments.

Referring to FIG. 6, the electronic apparatus 100 may identify whether a predetermined event occurred in the step S605. As an example, the predetermined event may include at least one of an event wherein a predetermined cycle arrives or an event wherein a user instruction requesting to obtain sensing data is received.

When the predetermined event occurs, the electronic apparatus 100 may obtain a driving map in the step S606. The driving map may be a map that was already generated and stored in advance in the electronic apparatus 100.

The electronic apparatus 100 may include a moving element 122. Also, the electronic apparatus 100 may be a mobile device. The electronic apparatus 100 may rotate the motor based on the supplied power. According to a rotation of the motor, the moving element 122 may be rotated. The electronic apparatus 100 may be moved based on the rotation and the direction of the moving element 122.

The electronic apparatus 100 may obtain sensing data while moving based on the driving map in the step S610. The electronic apparatus 100 may obtain a moving path based on the driving map. The electronic apparatus 100 may drive based on the moving path. The electronic apparatus 100 may obtain sensing data during driving. The electronic apparatus 100 may match the location wherein the sensing data is obtained with the sensing data when obtaining the sensing data, and store the information.

The electronic apparatus 100 may generate a sensing map by applying the sensing data to the driving map in the step S620. The electronic apparatus 100 may generate a sensing map to which the sensing data is reflected by considering the location wherein the sensing data was obtained. The user can easily recognize information on an environment of a specific space or a specific location based on the sensing map.

FIG. 7 is a diagram for illustrating a driving map according to one or more embodiments.

Referring to FIG. 7, the electronic apparatus 100 may obtain a driving map 700. The electronic apparatus 100 may set a moving path based on the driving map 700. The driving map 700 may be divided into a plurality of areas. The electronic apparatus 100 may identify a plurality of areas based on the driving map 700.

The driving map 700 may include the arrangement locations of the IoT devices 300 arranged in each of the plurality of areas. The driving map 700 may include the locations wherein the IoT devices 300 are arranged. The driving map 700 may include a device UI indicating the locations of the IoT devices 300.

As an example, the driving map 700 may be divided into a first space, a second space, a third space, and a fourth space. The driving map 700 may include the IoT devices 301-1, 302-1, 303-1, 304-1 arranged in the first space. The driving map 700 may include the IoT devices 301-2, 302-2, 303-2, 304-2 arranged in the second space. The driving map 700 may include the IoT devices 301-3, 302-3, 303-3, 304-3 arranged in the third space. The driving map 700 may include the IoT devices 301-4, 302-4, 303-4, 304-4 arranged in the fourth space.

The electronic apparatus 100 may identify a location of a specific IoT device based on the driving map 700.

FIG. 8 is a diagram for illustrating a sensing map according to one or more embodiments.

Referring to FIG. 8, the electronic apparatus 100 may generate a sensing map 800 based on a driving map. The sensing map 800 may include at least one environment UI. The environment UI may be a UI indicating an environment. As an example, the environment UI may be a UI indicating at least one of a temperature, humidity, illumination, or air pollution.

Referring to FIG. 8, the sensing data may include temperature data. The electronic apparatus 100 may generate the sensing map 800 including the environment UI based on the location wherein the sensing data was obtained.

As an example, the electronic apparatus 100 may obtain five pieces of sensing data indicating 24 degrees, 24 degrees, 24 degrees, 24 degrees, and 24 degrees in the first space. The electronic apparatus 100 may generate the sensing map 800 including the environment UI corresponding to the five pieces of sensing data.

As an example, the electronic apparatus 100 may obtain five pieces of sensing data indicating 23 degrees, 23 degrees, 24 degrees, 23 degrees, and 23 degrees in the second space. The electronic apparatus 100 may generate the sensing map 800 including the environment UI corresponding to the five pieces of sensing data.

As an example, the electronic apparatus 100 may obtain five pieces of sensing data indicating 20 degrees, 25 degrees, 25 degrees, 30 degrees, and 30 degrees in the third space. The electronic apparatus 100 may generate the sensing map 800 including the environment UI corresponding to the five pieces of sensing data.

As an example, the electronic apparatus 100 may obtain three pieces of sensing data indicating 25 degrees, 23 degrees, and 24 degrees in the fourth space. The electronic apparatus 100 may generate the sensing map 800 including the environment UI corresponding to the three pieces of sensing data.

The obtained sensing data may be filtered data. The electronic apparatus 100 may obtain one piece of sensing data by combining a plurality of pieces of sensing data. In FIG. 8, it was described that five or three pieces of sensing data are displayed for each space. However, each of such five pieces of data may indicate data wherein a plurality of pieces of sensing data were combined. As an example, the electronic apparatus 100 may obtain 50 pieces of sensing data in the first space. The electronic apparatus 100 may determine five locations representing the first space, and generate an environment UI for indicating five pieces of representative data.

The environment UI in FIG. 8 may include numbers indicating the sensing data. The user can intuitively recognize the sensing data through the numbers. The environment UI may include at least one of numbers or units indicating the sensing data. As an example, the unit of the temperature may be Celsius or Fahrenheit.

FIG. 9 is a diagram for illustrating a sensing map according to one or more embodiments.

Referring to the embodiment 910 in FIG. 9, the environment UI may include a predetermined character indicating the sensing data. As an example, the predetermined character may be at least one of L, M, or H. The predetermined character may also be described as a predetermined text.

Referring to the embodiment 920 in FIG. 9, the transparency (or the opacity) of the environment UI may vary according to the sensing data. The electronic apparatus 100 may generate the environment UI based on the transparency corresponding to the sensing data.

As an example, if the temperature is lower than or equal to a first threshold temperature, the electronic apparatus 100 may generate a sensing map including the environment UI of the first transparency. If the temperature exceeds the first threshold temperature and is lower than or equal to a second threshold temperature, the electronic apparatus 100 may generate a sensing map including the environment UI of the second transparency. If the temperature exceeds the second threshold temperature, the electronic apparatus 100 may generate a sensing map including the environment UI of the third transparency. The second threshold temperature may be higher than the first threshold temperature. At least some of the first transparency, the second transparency, or the third transparency may be different.

Referring to the embodiment 930 in FIG. 9, the environment UI may include different patterns according to the sensing data. The electronic apparatus 100 may generate the environment UI based on the patterns corresponding to the sensing data.

As an example, if the temperature is lower than or equal to the first threshold temperature, the electronic apparatus 100 may generate a sensing map including the environment UI of a first pattern. If the temperature exceeds the first threshold temperature but is lower than or equal to the second threshold temperature, the electronic apparatus 100 may generate a sensing map including the environment UI of a second pattern. If the temperature exceeds the second threshold temperature, the electronic apparatus 100 may generate a sensing map including the environment UI of a third pattern. The second threshold temperature may be higher than the first threshold temperature. At least some of the first pattern, the second pattern, or the third pattern may be different.

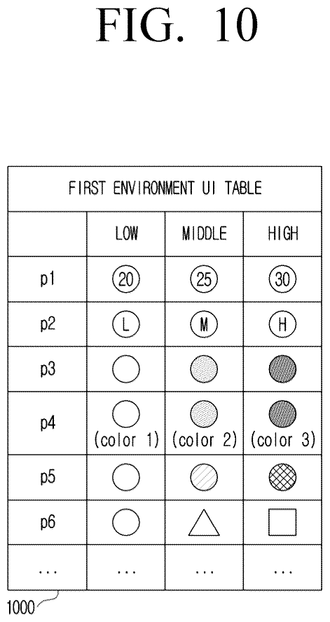

It was described that the transparency in the embodiment 920 and the patterns in the embodiment 930 are different, but the transparency may be a concept included in the patterns. FIG. 10 describes the patterns as a superordinate concept.

FIG. 10 is a diagram for illustrating an environment UI corresponding to sensing data according to one or more embodiments.

Referring to FIG. 10, the electronic apparatus 100 may store a first environment UI table 1000 in the memory 113. The electronic apparatus 100 may generate an environment UI corresponding to the sensing data based on the first environment UI table 1000.

The first environment UI table 1000 may determine a pattern of the environment UI corresponding to the sensing data. The electronic apparatus 100 may determine a group corresponding to the sensing data. The electronic apparatus 100 may classify the obtained sensing data into predetermined groups. The electronic apparatus 100 may determine a group (low, middle, high) corresponding to the sensing data according to a predetermined standard based on a value indicated by the sensing data. The electronic apparatus 100 may generate an environment UI based on a pattern corresponding to the determined group.

According to one or more embodiments p1, the electronic apparatus 100 may generate an environment UI including a sensing value (20, 25, 30) indicating the sensing data. A sensing value included in the environment UI may vary according to the sensing data.

According to one or more embodiments p2, the electronic apparatus 100 may generate an environment UI including a character (L, M, H) indicating a group corresponding to the sensing data. A character included in the environment UI may vary according to the sensing data.

According to one or more embodiments p3, the electronic apparatus 100 may generate an environment UI based on the transparency indicating a group corresponding to the sensing data. The transparency of the environment UI may vary according to the sensing data.

According to one or more embodiments p4, the electronic apparatus 100 may generate an environment UI based on a color (a first color, a second color, a third color) indicating a group corresponding to the sensing data. The color of the environment UI may vary according to the sensing data.

According to one or more embodiments p5, the electronic apparatus 100 may generate an environment UI based on an inner pattern indicating a group corresponding to the sensing data. The inner pattern of the environment UI may vary according to the sensing data.

According to one or more embodiments p6, the electronic apparatus 100 may generate an environment UI based on a shape indicating a group corresponding to the sensing data. The shape of the environment UI may vary according to the sensing data.

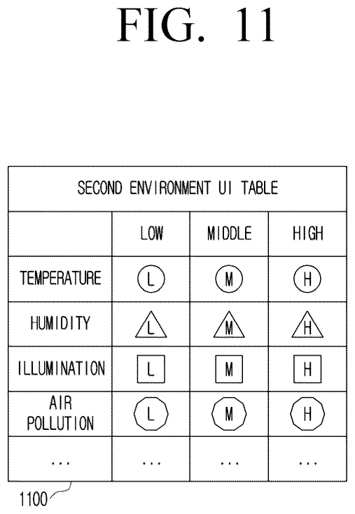

FIG. 11 is a diagram for illustrating an environment UI corresponding to sensing data according to one or more embodiments.

Referring to FIG. 11, the electronic apparatus 100 may store a second environment UI table 1100 in the memory 113.

The electronic apparatus 100 may generate an environment UI having different shapes according to the type of the sensing data (the temperature, the humidity, the illumination, the air pollution, etc.) based on the second environment UI table 1100.

As an example, the temperature may be expressed as an environment UI in a circular shape. The humidity may be expressed as an environment UI in a triangular shape. The illumination may be expressed as an environment UI in a square shape. The air pollution may be expressed as an environment UI in a polygonal shape.

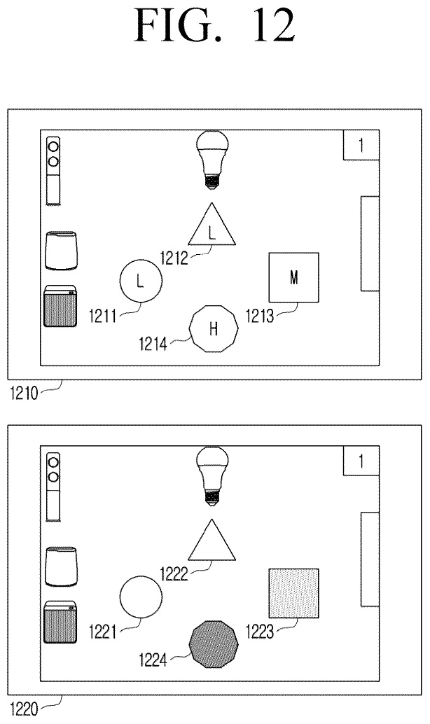

FIG. 12 is a diagram for illustrating an environment UI displayed on a sensing map according to one or more embodiments.

Referring to the embodiment 1210 in FIG. 12, the electronic apparatus 100 may generate an environment UI that indicates the type of the sensing data as a shape, and indicates a group corresponding to the sensing data as a character. The electronic apparatus 100 may generate the environment UI based on the second environment UI table 1100 in FIG. 11.

The environment UI 1211 may be a UI indicating the temperature corresponding to the first group.

The environment UI 1212 may be a UI indicating the humidity corresponding to the first group.

The environment UI 1213 may be a UI indicating the illumination corresponding to the second group.

The environment UI 1214 may be a UI indicating the air pollution corresponding to the third group.

The electronic apparatus 100 may generate a sensing map including the environment UIs (1211, 1212, 1213, 1214).

Referring to the embodiment 1220 in FIG. 12, the electronic apparatus 100 may generate an environment UI that indicates the type of the sensing data as a shape, and indicates a group corresponding to the sensing data as a predetermined pattern. As an example, the predetermined pattern may be the transparency or a color.

The environment UI 1221 may be a UI indicating the temperature corresponding to the first group.

The environment UI 1222 may be a UI indicating the humidity corresponding to the first group.

The environment UI 1223 may be a UI indicating the illumination corresponding to the second group.

The environment UI 1224 may be a UI indicating the air pollution corresponding to the third group.

The electronic apparatus 100 may generate a sensing map including the environment UIs (1221, 1222, 1223, 1224).

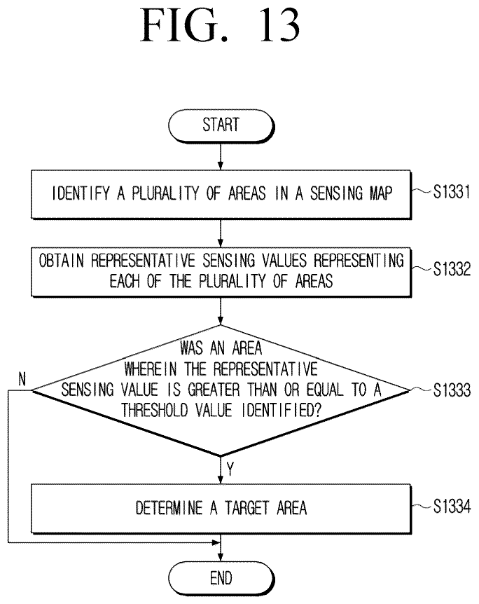

FIG. 13 is a diagram for illustrating an operation of determining a target area according to one or more embodiments.

Referring to FIG. 13, the electronic apparatus 100 may identify a plurality of areas in a sensing map in the step S1331. The electronic apparatus 100 may divide the plurality of areas based on the sensing map.

The electronic apparatus 100 may obtain representative sensing values representing each of the plurality of areas in the step S1332. The representative sensing values may include at least one of an average value or a variance value.

The electronic apparatus 100 may determine whether an area wherein the representative sensing value is greater than or equal to a threshold value is identified in the step S1333. The threshold value may be changed according to the type of the representative sensing value. Also, the threshold value may be changed by the user's setting.

If the representative sensing value is greater than or equal to the threshold value in the step S1333-Y, the electronic apparatus 100 may determine the area wherein the representative sensing value is greater than or equal to the threshold value as the target area in the step S1334.

As an example, if a representative sensing value is bigger than a pre-stored average value, the electronic apparatus 100 may determine the area wherein the representative sensing value was obtained as the target area.

FIG. 14 is a diagram for illustrating a calculation process used in determining a target area according to one or more embodiments.

Referring to the embodiment 1410 in FIG. 14, the electronic apparatus 100 may identify a target area based on sensing data related to the sensing map 800 in FIG. 8. The electronic apparatus 100 may calculate average temperatures for each of the plurality of areas. The electronic apparatus 100 may calculate an average temperature for all of the plurality of areas. The electronic apparatus 100 may obtain a difference value of an average temperature of a specific area from the entire average temperature. The electronic apparatus 100 may obtain the difference value by subtracting the average temperature of the specific area from the entire average temperature.

The electronic apparatus 100 may obtain an absolute value of the difference value. The electronic apparatus 100 may identify a target area by comparing the absolute value of the difference value and an average threshold value. If the absolute value of the difference value is greater than or equal to the average threshold value th1, the electronic apparatus 100 may determine the area that was used for calculation of the difference value as the target area.

Referring to the embodiment 1420 in FIG. 14, the electronic apparatus 100 may identify a target area based on sensing data related to the sensing map 800 in FIG. 8. The electronic apparatus 100 may obtain a variance value based on the absolute value of the difference value obtained in the embodiment 1410. The electronic apparatus 100 may identify a target area by comparing the variance value and a variance threshold value. If the variance value is greater than or equal to the variance threshold value th2, the electronic apparatus 100 may determine the area that was used for calculation of the variance value as the target area.

The average threshold value th1 and the variance threshold value th2 may be changed according to the user's setting.

FIG. 15 is a diagram for illustrating an operation of generating a control command for controlling a target device according to one or more embodiments.

Referring to FIG. 15, the electronic apparatus 100 may obtain a representative sensing value representing a target area in the step S1541. When the target area is determined, the electronic apparatus 100 may obtain a representative sensing value representing the target area. As an example, the representative sensing value representing the target area may be an average value of the sensing data obtained in the target area.

The electronic apparatus 100 may obtain an average sensing value representing a space including a plurality of areas in the step S1542. The electronic apparatus 100 may obtain an average sensing value corresponding to the entire space.

The electronic apparatus 100 may obtain a difference value between the average sensing value obtained in the step S1542 and the representative sensing value obtained in the step S1541 in the step S1543. The electronic apparatus 100 may obtain the difference value by subtracting the difference value of the representative sensing value from the average sensing value.

The electronic apparatus 100 may obtain a correction value for controlling the environment of the target area based on the difference value in the step S1544.

As an example, the electronic apparatus 100 may obtain the difference value itself as the correction value.

As an example, the electronic apparatus 100 may obtain a value of converting the difference value into a predetermined function as the correction value. The predetermined function may vary according to the type of the sensing data.

The electronic apparatus 100 may identify a target device corresponding to the representative sensing value in the step S1550. The electronic apparatus 100 may identify a target device related to the representative sensing value. As an example, if the representative sensing value is a temperature, the electronic apparatus 100 may identify an IoT device 300 for controlling a temperature as the target device. The target device may be an IoT device 300 corresponding to the target area.

As an example, in case an IoT device 300 for controlling the representative sensing value exists in the target area, the electronic apparatus 100 may determine the IoT device 300 existing in the target area as the target device.

As an example, in case an IoT device 300 for controlling the representative sensing value does not exist in the target area, the electronic apparatus 100 may determine an IoT device 300 existing in an area adjacent to the target area as the target device.

The electronic apparatus 100 may identify a control code corresponding to the identified target device in the step S1555. A code related to a control command may vary for each target device. When the target device is determined, the electronic apparatus 100 may identify a control code corresponding to the target device. The electronic apparatus 100 may store a control code set including control codes corresponding to each of the plurality of target devices in the memory 113.

The electronic apparatus 100 may obtain a control code corresponding to the target device among the plurality of control codes based on the control code set stored in the memory 113.

The electronic apparatus 100 may generate a control command for controlling the target device as much as the correction value based on the control code corresponding to the target device in the step S1560.

As an example, it is assumed that in the embodiments 1410, 1420 in FIG. 14, the target area is the third area. The representative sensing value representing the target area may be 26. The representative sensing value representing the space may be 24.3. The correction value may be −1.7. The electronic apparatus 100 may identify a target device for lowering the temperature by −1.7. The electronic apparatus 100 may transmit a control command for lowering the temperature by −1.7 to the target device.

FIG. 16 is a diagram for illustrating an operation of transmitting a control command by using signal strength according to one or more embodiments.

Referring to FIG. 16, when the target device is determined (the step S550 in FIG. 5, the step S1550 in FIG. 15), the electronic apparatus 100 may identify a target location corresponding to the target device in the step S1671. The target location may indicate the location wherein the target device is arranged among the plurality of locations on the sensing map.

The electronic apparatus 100 may obtain signal strength of the AP device 400 corresponding to the target location in the step S1672. The electronic apparatus 100 may sense (or measure) the signal strength of the AP device 400 in a plurality of locations of the space. The sensing map may include the signal strength of the AP device 400 according to the locations. Explanation related to this will be described in FIG. 17 and FIG. 18.

The electronic apparatus 100 may identify whether the signal strength corresponding to the target location is smaller than threshold strength in the step S1673. The threshold strength may be changed according to the user's setting.

As mentioned in FIG. 15, it is assumed that a target device and a control command for controlling the target device were generated.

If the signal strength is smaller than threshold strength in the step S1673-Y, the electronic apparatus 100 may move to the target location in the step S1674. The electronic apparatus 100 may transmit the control command to the target device in the step S1675.

If the signal strength is greater than or equal to the threshold strength in the step S1673-N, the electronic apparatus 100 may transmit the control command to the target device through the AP device 400 in the step S1676.

If the signal strength is low, the control command may not be transmitted to the target device normally. The electronic apparatus 100 may move to the target location wherein the signal strength is low, and the electronic apparatus 100 may directly transmit the control command to the target device. Even for a location wherein signal strength with the AP device 400 is relatively low, the control command can be transmitted to the target device correctly.

FIG. 17 is a diagram for illustrating a sensing map indicating signal strength according to one or more embodiments.

Referring to FIG. 17, the electronic apparatus 100 may measure the signal strength with the AP device 400 while moving based on a driving path. The electronic apparatus 100 may measure the signal strength of the AP device 400 in a plurality of locations. The electronic apparatus 100 may generate a sensing map including the signal strength corresponding to the plurality of locations.

Referring to the embodiment 1700 in FIG. 17, the electronic apparatus 100 may determine the representative signal strength for each of the divided spaces. The representative signal strength may indicate the average signal strength of the spaces. The electronic apparatus 100 may generate a sensing map including signal strength UIs 1710, 1720, 1730, 1740 indicating the representative signal strength for each space.

It is assumed that the third space is determined as a target area, and the representative signal strength of the third space is smaller than the threshold strength. The electronic apparatus 100 may determine that a control command for controlling the environment of the third space was not transmitted correctly. The electronic apparatus 100 may transmit a control command to the target device after moving to the third space.

The moving path of the electronic apparatus 100 displayed in FIG. 17 may not be included in the sensing map.

FIG. 18 is a diagram for illustrating a sensing map indicating signal strength according to one or more embodiments.

Referring to the embodiment 1800 in FIG. 18, the electronic apparatus 100 may generate a sensing map that divides the representative signal strength corresponding to each of a plurality of areas into patterns for each space. The electronic apparatus 100 may determine groups corresponding to the representative signal strength. The electronic apparatus 100 may generate the sensing map based on predetermined patterns corresponding to the determined groups.

FIG. 18 may indicate a sensing map that expresses a space in a more intense pattern as the signal strength is stronger.

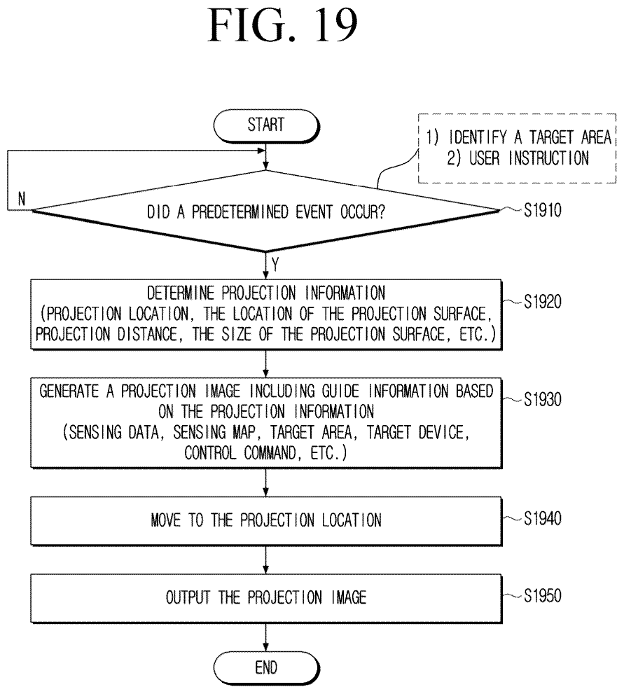

FIG. 19 is a diagram for illustrating an operation of outputting a projection image according to one or more embodiments.

Referring to FIG. 19, the electronic apparatus 100 may identify whether a predetermined event occurs in the step S1910. The predetermined event may include at least one of an event wherein a target area is identified or an event wherein a user instruction for outputting a projection image was input.

If the predetermined event occurs in the step S1910-Y, the electronic apparatus 100 may determine projection information. The projection information may include at least one of a projection location, the location of the projection surface, a projection distance, or the size of the projection surface.

The projection location may indicate the location of a device for outputting a projection image.

The location of the projection surface may indicate the location of the surface wherein a light corresponding to the projection image is output.

The projection distance may indicate the distance between the projection location and the projection surface.

The size of the projection surface may indicate the output size of the projection image. As the size of the projection surface is bigger in the same location and the same distance, the size of the projection image output on the projection surface may also become bigger.

The electronic apparatus 100 may output the projection image based on a predetermined projection ratio. The electronic apparatus 100 may determine the size (or the resolution) of the projection image based on the projection distance, the predetermined projection ratio, and the size of the projection surface.

The electronic apparatus 100 may generate a projection image including guide information based on the projection information in the step S1930. The guide information may include information to be provided to the user. The guide information may include at least one of sensing data, a sensing map, a target area, a target device, or a control command.

The electronic apparatus 100 may move to the projection location included in the projection information in the step S1940. The electronic apparatus 100 may output the projection image to the location of the projection surface in the projection location in the step S1950. The electronic apparatus 100 may output the projection image based on the predetermined projection ratio in the step S1950.

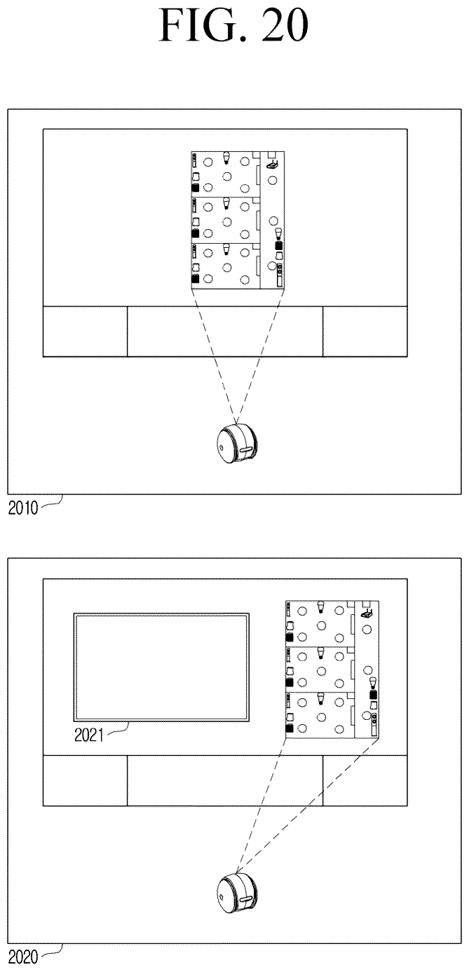

FIG. 20 is a diagram for illustrating an operation of outputting a projection image according to one or more embodiments.

Referring to the embodiment 2010 in FIG. 20, the electronic apparatus 100 may determine a location of a projection surface for outputting a projection image. The electronic apparatus 100 may determine the location of the projection surface based on a wall surface wherein there is no obstacle.

Referring to the embodiment 2020 in FIG. 20, the electronic apparatus 100 may determine a location of a projection surface based on an area wherein an obstacle 2021 is not arranged. An obstacle may be described as a predetermined object. A predetermined object may indicate an object that becomes a hindrance when a projection image is output.

In FIG. 19 and FIG. 20, an operation of outputting a projection image was explained. According to another embodiment, the electronic apparatus 100 may generate a screen including guide information. The electronic apparatus 100 may transmit the screen including guide information to an external display device. The electronic apparatus 100 may transmit information on the screen to the external display device through a port included in the input/output interface 116. The external display device may display the screen received from the electronic apparatus 100.

According to another embodiment, the electronic apparatus 100 may include a display. The electronic apparatus 100 may directly display a screen on the display.

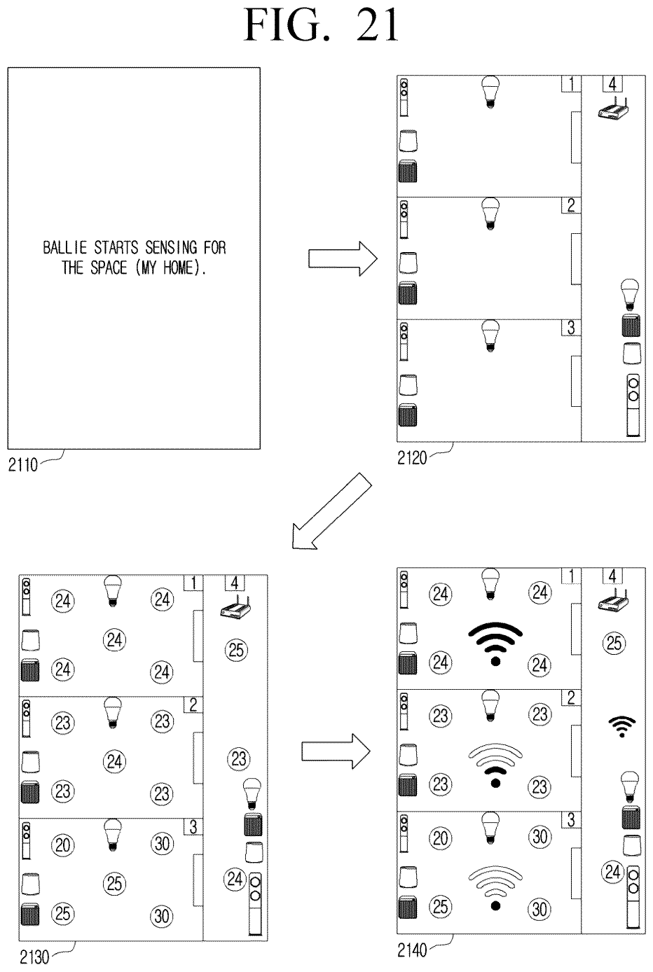

FIG. 21 is a diagram for illustrating an operation of displaying a sensing map for each step according to one or more embodiments.

Referring to FIG. 21, the electronic apparatus 100 may provide a process of generating and updating a sensing map to the user.

The electronic apparatus 100 may provide a guide screen 2110 for starting generation of a sensing map to the user. After the guide screen 2110 is provided, the electronic apparatus 100 may obtain a driving map 2120. The electronic apparatus 100 may provide the driving map 2120 to the user.

The electronic apparatus 100 may obtain sensing data related to the environment while moving based on the driving map 2120. The electronic apparatus 100 may obtain a sensing map 2130 based on the sensing data related to the environment. The electronic apparatus 100 may provide the sensing map 2130 to the user.

The electronic apparatus 100 may apply signal strength with the AP device 400 to the sensing map 2130. The electronic apparatus 100 may generate (or update) a sensing map 2140 indicating the signal strength with the AP device 400. The electronic apparatus 100 may provide the sensing map 2140 to the user.

The operation of providing a screen or a sensing map to the user may include one of an operation of displaying the screen or the sensing map through a terminal device of the user, an operation of displaying the screen or the sensing map on the display included in the electronic apparatus 100, or an operation of displaying the screen or the sensing map on a display included in the IoT device 300.

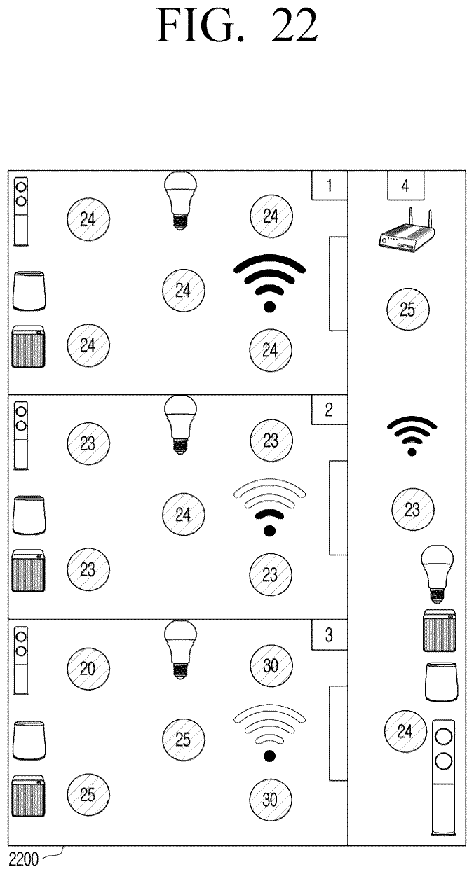

FIG. 22 is a diagram for illustrating a sensing map including an environment UI and a signal UI according to one or more embodiments.

Referring to the embodiment 2200 in FIG. 22, the electronic apparatus 100 may generate a sensing map including an environment UI indicating sensing data related to the environment and a signal strength UI indicating signal strength with the AP device 400.

The environment UI may include a sensing value (e.g., a temperature value) in a predetermined shape (e.g., a circle).

The signal strength UI may include information indicating signal strength (e.g., an image or an icon) in a predetermined shape (e.g., a fan shape).

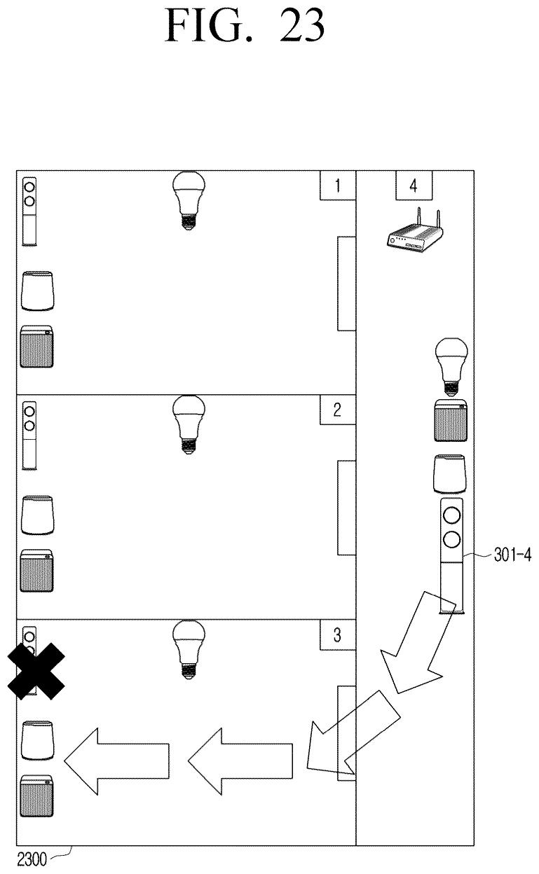

FIG. 23 is a diagram for illustrating an operation of controlling an environment of another space according to one or more embodiments.

Referring to the embodiment 2300 in FIG. 23, it is assumed that the third area is a target area. Also, it is assumed that a target device does not exist in the third area, or a target device in the third area is in a broken state. The electronic apparatus 100 may determine a target device for controlling the environment (e.g., the temperature) of the third area which is the target area.

As an example, in case a target device does not exist in the third area, the electronic apparatus 100 may determine an IoT device 301-4 existing in the fourth area adjacent to the third area as the target device. The electronic apparatus 100 may control the environment of the third area by using the target device existing in the fourth area.

As an example, the electronic apparatus 100 may determine a wind direction based on a location corresponding to the third area. The electronic apparatus 100 may determine the strength of the wind flow based on a distance between the location corresponding to the third area and the target device. The electronic apparatus 100 may generate a control command for controlling the environment as much as a correction value based on the determined wind direction and the determined strength of the wind flow. The electronic apparatus 100 may transmit the control command to the target device. The target device may perform a predetermined operation (blowing wind in the direction of the third area) by the control command.

The electronic apparatus 100 may simultaneously control a plurality of target devices.

According to another embodiment, it is assumed that the temperature of the third area is higher than those of the first area and the second area by greater than or equal to a threshold temperature. The electronic apparatus 100 may use not only a first target device existing in the third area but also an IoT device existing in the fourth area adjacent to the third area as a second target device. The electronic apparatus 100 may control the environment of the third area by using the plurality of target devices. The electronic apparatus 100 may change the temperature of the third area through the first target device. The electronic apparatus 100 may control the temperature of the third area by controlling the second target device arranged in the fourth area at the same time as controlling the first target device arranged in the third area.

In the case of controlling a target device for controlling the environment of another area, the electronic apparatus 100 may control the output of the target device to the maximum. In case a specific mode for a maximum output exists, the electronic apparatus 100 may operate in the specific mode. In addition, the electronic apparatus 100 may additionally control a sub target device that is helpful for a maximum output.

As an example, in case the temperature of the third area is higher than that of another area by greater than or equal to the threshold temperature, the electronic apparatus 100 may control an air conditioner of the third area and an air conditioner of the fourth area together to lower the temperature of the third area. The electronic apparatus 100 may control the air conditioner of the fourth area to a maximum output. The electronic apparatus 100 may additionally control a fan (or a circulator) of the fourth area to help with the output of the air conditioner of the fourth area. The electronic apparatus 100 may control the fan of the fourth area such that the direction of the wind output from the fan is toward the third area.

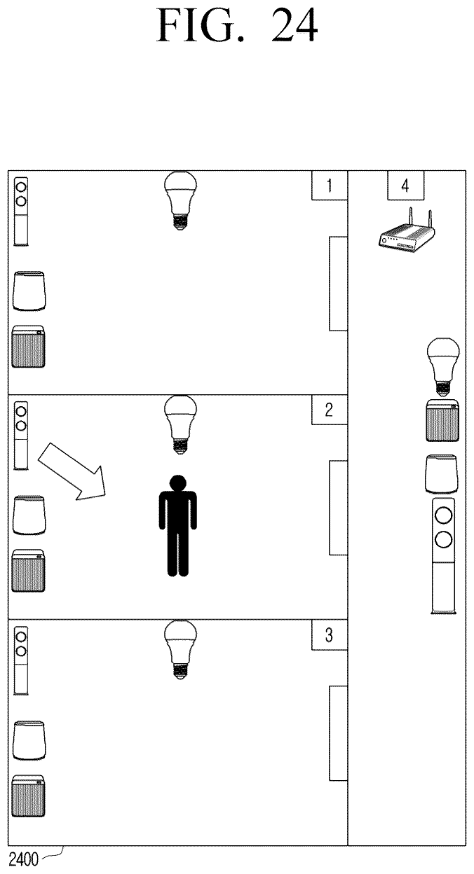

FIG. 24 is a diagram for illustrating an operation of recognizing a user according to one or more embodiments.

Referring to the embodiment 2400 in FIG. 24, the electronic apparatus 100 may determine a target area based on the location of the user. The electronic apparatus 100 may determine the priority of the target area based on the location of the user. The electronic apparatus 100 may grant a higher priority to the location wherein the user exists.

The electronic apparatus 100 may identify the location of the user, and identify an area corresponding to the location of the user. The electronic apparatus 100 may determine the area wherein the user exists as the target area. The electronic apparatus 100 may generate a control command for controlling the environment for the target area wherein the user exists.

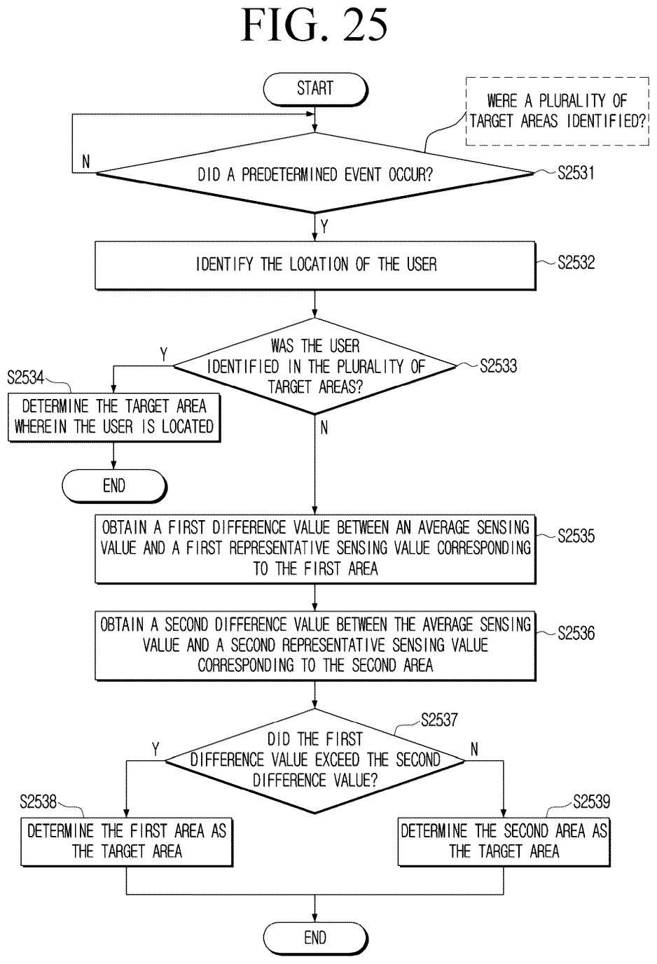

FIG. 25 is a diagram for illustrating an operation of controlling a target device in consideration of existence of a user according to one or more embodiments.

Referring to FIG. 25, the electronic apparatus 100 may identify whether a predetermined event occurs in the step S2531. The predetermined event may include an event wherein a plurality of target areas are identified. Also, the predetermined event may include an event wherein a plurality of target areas satisfying a predetermined condition are identified. In FIG. 14, a situation wherein one area is identified as a target area was illustrated. According to another embodiment, a plurality of areas may be determined as target areas.

If a predetermined event occurs in the step S2531-Y, the electronic apparatus 100 may identify the location of the user in the step S2532.

As an example, if a predetermined event occurs, the electronic apparatus 100 may obtain image data through an image sensor in the current location. The electronic apparatus 100 may identify the user based on the image data. The electronic apparatus 100 may identify a pre-stored human object in the image data. When a human object is identified, the electronic apparatus 100 may determine the location wherein the human object was identified as the location of the user.

As an example, the electronic apparatus 100 may obtain image data together with sensing data during driving. The electronic apparatus 100 may include an image sensor. The electronic apparatus 100 may obtain image data through the image sensor. The electronic apparatus 100 may identify the location of the user based on the image data obtained during driving, and store the location of the user in the memory 113. If a human object is identified in the image data, the electronic apparatus 100 may determine the location corresponding to the human object as the location of the user. The electronic apparatus 100 may store the determined location of the user in the memory 113. If a predetermined event occurs, the electronic apparatus 100 may identify the location of the user stored in the memory 113.

The electronic apparatus 100 may identify whether the user is identified in the plurality of target areas in the step S2533. The electronic apparatus 100 may determine whether the location of the user is included in one of the plurality of target areas.

If the user is identified in the plurality of target areas in the step S2533-Y, the electronic apparatus 100 may determine the area including the location of the user as the target area (the final target area) in the step S2534.

If the user is not identified in the plurality of target areas in the step S2533-N, the electronic apparatus 100 may determine an area as the target area. The electronic apparatus 100 may determine an area wherein change of the environment is needed more urgently among the plurality of target areas as the final target area. An area in greater need of attention may be determined according to predetermined priorities.

As an example, an area wherein a value associated with a particular environmental factor varies greatly from an average value may have a higher priority.

As an example, an area wherein a variance value for the environment is higher may have a higher priority.

It is assumed that the plurality of target areas are a first area and a second area.

The electronic apparatus 100 may obtain a first difference value between an average sensing value and a first representative sensing value corresponding to the first area in the step S2535.

The electronic apparatus 100 may obtain a second difference value between the average sensing value and a second representative sensing value corresponding to the second area in the step S2536.

The electronic apparatus 100 may compare the first difference value and the second difference value. The electronic apparatus 100 may identify whether the first difference value exceeds the second difference value in the step S2537.

If the first difference value exceeds the second difference value in the step S2537-Y, the electronic apparatus 100 may determine the first area as the target area in the step S2538.

If the first difference value does not exceed the second difference value in the step S2537-N, the electronic apparatus 100 may determine the second area as the target area in the step S2539.

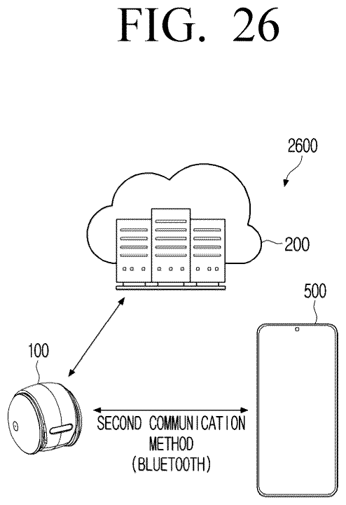

FIG. 26 is a diagram for illustrating a plurality of communication methods according to one or more embodiments.

Referring to the embodiment 2600 in FIG. 26, the electronic apparatus 100 may be communicatively connected with a server 200 and a terminal device 500.

The electronic apparatus 100 may be communicatively connected with the server 200 through a first communication method. The electronic apparatus 100 may be communicatively connected with the terminal device 500 through a second communication method.

The first communication method and the second communication method may be different. As an example, the first communication method may be a Wi-Fi communication method. The second communication method may be a Bluetooth communication method.

The electronic apparatus 100 may include a communication interface 114. The communication interface 114 may include a first communication module and a second communication module. As an example, the first communication module may be a Wi-Fi communication module. The second communication module may be a Bluetooth communication module.

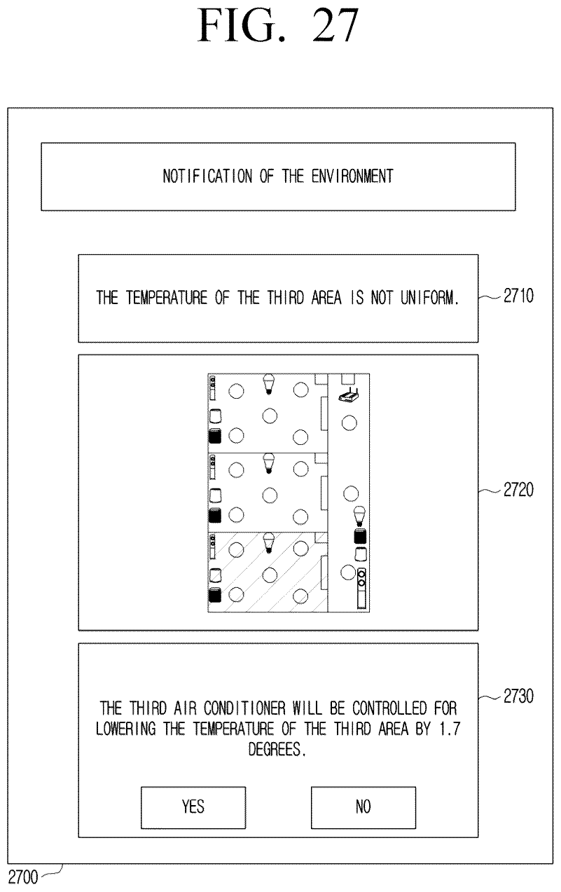

FIG. 27 is a diagram for illustrating a screen related to environment control according to one or more embodiments.

Referring to FIG. 27, the electronic apparatus 100 may generate a guide screen 2700. The electronic apparatus 100 may provide the guide screen 2700. The guide screen 2700 may include guide information. The guide information may include information to be provided to the user. The guide information may include at least one of sensing data, a sensing map, a target area, a target device, or a control command.

The guide screen 2700 may include at least one of a UI 2710 indicating occurrence of a target area, a UI 2720 indicating a sensing map, or a UI 2730 indicating a control command for controlling a target device.

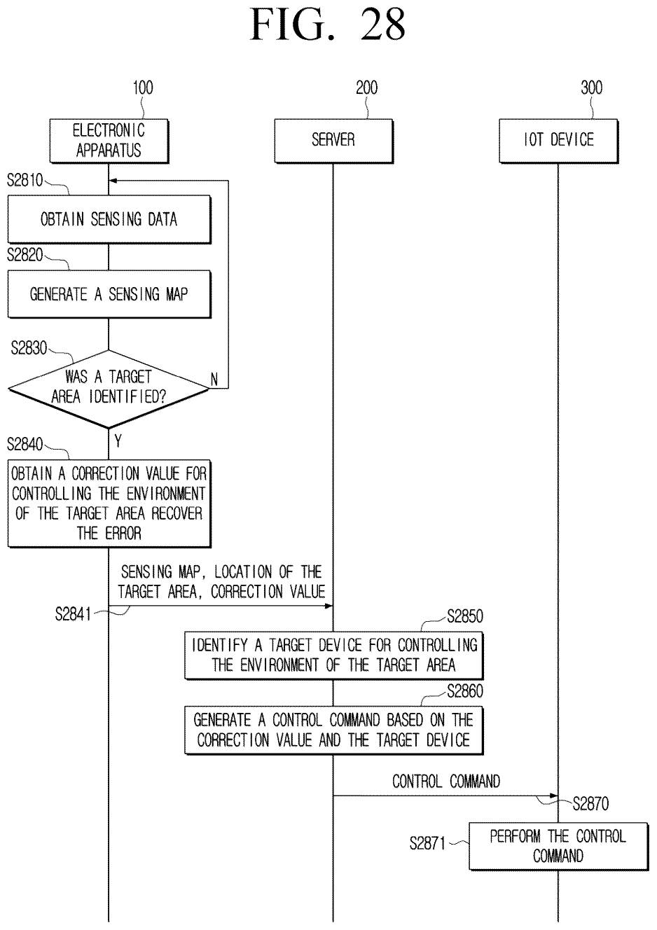

FIG. 28 is a diagram for illustrating an operation of transmitting a control command to the IoT device 300 through the server 200 according to one or more embodiments.

The steps S2810, S2820, S2830, S2840, S2850, and S2860 in FIG. 28 may correspond to the steps S510, S520, S530, S540, S550, and S560 in FIG. 5. In FIG. 5, a subject generating a control command was the electronic apparatus 100. In the embodiment in FIG. 28, the server 200 may generate a control command. An operation performed by the electronic apparatus 100 related to generation of a control command may be performed in the server 200. Accordingly, overlapping explanation will be omitted.

When a correction value for controlling the environment of the target area is obtained, the electronic apparatus 100 may transmit the sensing map, the location of the target area, and the correction value to the server 200 in the step S2841.

The server 200 may receive the sensing map, the location of the target area, and the correction value from the electronic apparatus 100. The server 200 may identify a target device for controlling the environment of the target area in the step S2850. The server 200 may identify a target device corresponding to the location of the target area among a plurality of IoT devices included in the sensing map. The target device will be described as the IoT device 300.

The server 200 may generate a control command based on the correction value and the target device in the step S2860. The server 200 may transmit the control command to the IoT device 300 in the step S2870.

The IoT device 300 may receive the control command from the server 200. The IoT device 300 may perform the control command in the step S2871.

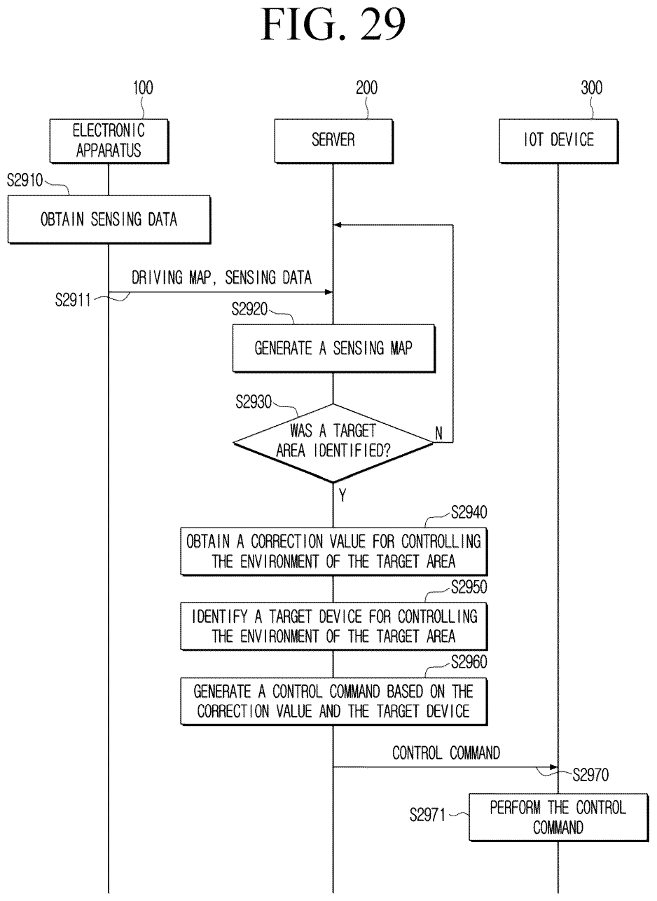

In FIG. 28, the sensing map was generated by the electronic apparatus 100. In FIG. 29, one or more embodiments wherein the server 200 generates a sensing map will be explained.

FIG. 29 is a diagram for illustrating an operation of generating a sensing map at the server 200 according to one or more embodiments.

The steps S2910, S2920, S2930, S2940, S2950, and S2960 in FIG. 29 may correspond to the steps S510, S520, S530, S540, S550, and S560 in FIG. 5. In FIG. 5, a subject generating a sensing map was the electronic apparatus 100. In the embodiment in FIG. 29, the server 200 may generate a sensing map. An operation performed by the electronic apparatus 100 related to generation of a sensing map may be performed in the server 200. Accordingly, overlapping explanation will be omitted.

It is assumed that the electronic apparatus 100 stores a driving map. When sensing data is obtained, the electronic apparatus 100 may transmit the driving map and the sensing data to the server 200 in the step S2911.

As an example, the electronic apparatus 100 may transmit the driving map and the sensing data simultaneously to the server 200.

As an example, the electronic apparatus 100 may transmit the driving map to the server 200 before transmitting the sensing data to the server 200.

The server 200 may receive the driving map and the sensing data from the electronic apparatus 100. The server 200 may generate a sensing map in the step S2920. The server 200 may determine whether a target area is identified based on the sensing map in the step S2930.

If a target area is identified in the step S2930-Y, the server 200 may obtain a correction value for controlling the environment of the target area in the step S2940. The server 200 may identify a target device for controlling the environment of the target area in the step S2950. The server 200 may generate a control command based on the correction value and the target device in the step S2960. The target device will be described as the IoT device 300. The server 200 may transmit the control command to the IoT device 300.

The IoT device 300 may receive the control command from the server 200. The IoT device 300 may perform the control command in the step S2971.

In FIG. 28 and FIG. 29, it was explained that the server 200 transmits a control command to the IoT device 300. As in the embodiment 420 in FIG. 4, a control command may be transmitted to the IoT device 300 via the AP device 400.

According to another embodiment, a control command may be directly transmitted to the IoT device 300 from the electronic apparatus 100. In case a control command is generated in the electronic apparatus 100, the electronic apparatus 100 may directly transmit the control command to the IoT device 300 not via the server 200.

As an example, the electronic apparatus 100 may move to the location of the target device, and transmit the control command to the IoT device 300.

As an example, in the event signal strength corresponding to the target location is smaller than threshold strength, the electronic apparatus 100 may move to the location of the target device, and transmit the control command to the IoT device 300. Explanation related to this will be described in FIG. 16.

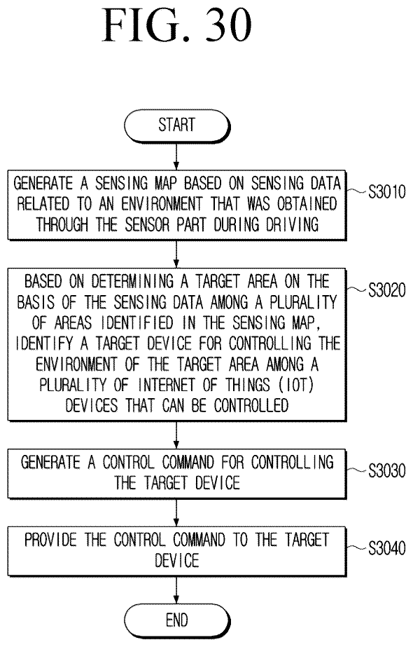

FIG. 30 is a diagram for illustrating a controlling method of the electronic apparatus 100 according to one or more embodiments.

Referring to FIG. 30, a controlling method of an electronic apparatus including a sensor part may include the steps of generating a sensing map based on sensing data related to an environment that was obtained through the sensor part during driving (S3010), and based on determining a target area, on the basis of the sensing data among a plurality of areas identified in the sensing map, identifying a target device for controlling the environment of the target area among a plurality of Internet of Things (IoT) devices that can be controlled (S3020), generating a control command for controlling the target device (S3030), and providing the control command to the target device (S3040).

The sensor part may include at least one of a temperature sensor, a humidity sensor, an illumination sensor, or an air pollution sensor, and the sensing data may include data related to at least one of a temperature, humidity, illumination, air pollution, or ozone concentration.

The air pollution sensor may include at least one of a first air pollution sensor that measures chemical pollution and a second air pollution sensor that measures particulate pollution.

The electronic apparatus 100 may include a moving element, and in the step S3010 of generating the sensing map, the electronic apparatus 100 may obtain a moving path based on a driving map stored in the electronic apparatus 100, obtain the sensing data while driving based on the moving path, and generate the sensing map by applying the sensing data to the driving map.

In the step S3010 of generating the sensing map, the electronic apparatus 100 may, while driving based on the moving path, obtain signal data indicating signal strength of an access point (AP) device connected with the IoT devices, and generate the sensing map by applying the sensing data and the signal data to the driving map.

The controlling method may include the steps of, based on determining a target area, obtaining signal strength corresponding to the location of the target area, and based on the signal strength being greater than or equal to threshold strength, transmitting a control command to the target device through the AP device.

The controlling method may include the steps of, based on the signal strength being smaller than the threshold strength, moving to a target location, and directly transmitting a control command to the target device.

The sensing map may include at least one environment UI indicating a sensing value included in the sensing data.

The controlling method may include the steps of obtaining a plurality of representative sensing values indicating each of the plurality of areas included in the sensing map, obtaining an average sensing value of the plurality of representative sensing values, and determining an area wherein a difference value between the representative sensing value and the average sensing value is greater than or equal to a threshold value as the target area.

In the step S3030 of generating the control command, a correction value for controlling the environment of the target area may be obtained based on the difference value, and the control command may be generated based on a control code corresponding to the identified target device and the correction value.

Meanwhile, methods according to the aforementioned various embodiments of the disclosure may be implemented in forms of applications that can be installed on conventional electronic apparatuses.

Also, the methods according to the aforementioned various embodiments of the disclosure may be implemented just with software upgrade, or hardware upgrade of conventional electronic apparatuses.

In addition, the aforementioned various embodiments of the disclosure may be performed through an embedded server provided on an electronic apparatus, or an external server of at least one of an electronic apparatus or a display device.

Meanwhile, according to one or more embodiments of the disclosure, the aforementioned various embodiments may be implemented as software including instructions stored in machine-readable storage media, which can be read by machines (e.g., computers). The machines refer to apparatuses that call instructions stored in a storage medium, and can operate according to the called instructions, and the apparatuses may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to one or more embodiments of the disclosure, the methods according to the aforementioned various embodiments of the disclosure may be provided while being included in a computer program product. A computer program product refers to a product, and it can be traded between a seller and a buyer. A computer program product can be distributed on-line in the form of a storage medium that is readable by machines (e.g., compact disc read only memory (CD-ROM)), or through an application store. In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned various embodiments (e.g., a module or a program) may consist of a singular object or a plurality of objects, and among the aforementioned corresponding sub components, some sub components may be omitted, or other sub components may be further included in the various embodiments. Alternatively or additionally, some components (e.g., a module or a program) may be integrated as an object, and perform functions that were performed, substantially identically, by each of the components before integration. Also, operations performed by a module, a program, or other components according to the various embodiments may be executed sequentially, in parallel, repetitively, or heuristically. Alternatively, at least some of the operations may be omitted or executed in a different order, or other operations may be added.

Further, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or scope of the disclosure.

What is claimed is:

1. An electronic apparatus comprising:
memory storing instructions;
a communication interface;
a sensor part; and
at least one processor including processing circuitry,
wherein the instructions, when executed by the at least one processor individually or collectively, cause the electronic apparatus to:
obtain a map based on sensing data related to an environment, the sensing data being obtained through the sensor part while the electronic apparatus is being driven,
based on a target area that is determined based on the sensing data existing among a plurality of areas in the map, identify a target device corresponding to control of the environment of the target area among a plurality of external devices, and
transmit a control command through the communication interface to the target device for controlling the target device.

2. The electronic apparatus of claim 1,
wherein the sensor part comprises:
at least one of a temperature sensor, a humidity sensor, an illumination sensor, or an air pollution sensor, and
wherein the sensing data comprises data related to:
at least one of a temperature, humidity, illumination, air pollution, or ozone concentration.

3. The electronic apparatus of claim 2,
wherein the air pollution sensor comprises:
a first air pollution sensor configured to measure chemical pollution and a second air pollution sensor configured to measure particulate pollution.

4. The electronic apparatus of claim 1,
wherein the electronic apparatus comprises:
a moving element, and
wherein the instructions, when executed by the at least one processor individually or collectively, further cause the electronic apparatus to:
obtain a moving path based on a driving map stored in the memory,
obtain the sensing data while the electronic device is being driven based on the moving path, and
obtain the map from the driving map based on the obtained sensing data.

5. The electronic apparatus of claim 4,
wherein the instructions, when executed by the at least one processor individually or collectively, further cause the electronic apparatus to:
while moving based on the moving path, obtain signal data corresponding to signal strength of an access point (AP) device wirelessly connected with the plurality of external devices, and
obtain the map from the driving map based on the obtained signal data.

6. The electronic apparatus of claim 5,
wherein the instructions, when executed by the at least one processor individually or collectively, further cause the electronic apparatus to:
based on the target area, on the basis of the sensing data existing, obtain signal strength corresponding to a target location of the target area, and
based on the signal strength being greater than or equal to a threshold value, transmit the control command to the target device through the communication interface via the AP device.

7. The electronic apparatus of claim 6,
wherein the instructions, when executed by the at least one processor individually or collectively, further cause the electronic apparatus to:
based on the signal strength being smaller than the threshold value, perform control to move to the target location through the moving element, and
transmit the control command to the target device through the communication interface in the target location to which the electronic apparatus moved.

8. The electronic apparatus of claim 1,
wherein the map comprises:
at least one environment UI indicating a sensing value included in the sensing data.

9. The electronic apparatus of claim 1,
wherein the instructions, when executed by the at least one processor individually or collectively, further cause the electronic apparatus to:
obtain a plurality of representative sensing values corresponding to each of the plurality of areas included in the map, and
obtain an area having a representative sensing value of the plurality of representative sensing values, wherein a difference value between an average sensing value obtained from the plurality of representative sensing values and the representative sensing value is greater than or equal to a threshold value of the target area.

10. The electronic apparatus of claim 9,
wherein the instructions, when executed by the at least one processor individually or collectively, further cause the electronic apparatus to:
obtain a correction value corresponding to the control of the environment of the target area based on the difference value, and
obtain the control command based on a control code corresponding to the identified target device and the correction value.

11. A controlling method of an electronic apparatus comprising a sensor part,
wherein the controlling method comprises:
obtaining a map based on sensing data related to an environment that was obtained by the sensor part while the electronic apparatus is being driven;
based on a target area that is determined based on the sensing data existing among a plurality of areas in the map, identifying a target device corresponding to control of the environment of the target area among a plurality of external devices; and
transmitting a control command to the target device for controlling the target device.

12. The controlling method of claim 11,
wherein the sensor part comprises:
at least one of a temperature sensor, a humidity sensor, an illumination sensor, or an air pollution sensor, and
wherein the sensing data comprises data relating to:
at least one of a temperature, humidity, illumination, air pollution, or ozone concentration.

13. The controlling method of claim 12,
wherein the air pollution sensor comprises:
a first air pollution sensor configured to measure chemical pollution and a second air pollution sensor configured to measure particulate pollution.

14. The controlling method of claim 11,
wherein the electronic apparatus comprises:
a moving element, and
wherein the obtaining the map comprises:
obtaining a moving path based on a driving map stored in the electronic apparatus;
obtaining the sensing data while driving based on the moving path; and
obtaining the map from the driving map based on the obtained sensing data.

15. The controlling method of claim 14,
wherein the obtaining the map comprises:
while moving based on the moving path, obtaining signal data corresponding to signal strength of an access point (AP) device wirelessly connected with the plurality of external devices; and
obtaining the map from the driving map based on the obtained signal data.
